(19) United States
(12) Patent Application Publication
(10) Pub. No.: US 2023/0012880 A1
(43) Pub. Date: Jan. 19, 2023

(54) LEVEL-AWARE CACHE REPLACEMENT

(71) Applicant: Nuvia, Inc., San Diego, CA (US)

(72) Inventor: Amit KUMAR, Fremont, CA (US)

(21) Appl. No.: 17/666,429

(22) Filed: Feb. 7, 2022

Related U.S. Application Data
(60) Provisional application No. 63/221,875, filed on Jul. 14, 2021.

(51) Int. Cl. G06F 12/0811; G06F 12/0862; G06F 12/0831; G06F 12/1045

(52) U.S. Cl. CPC G06F 12/0811; G06F 12/0862; G06F 12/0833; G06F 12/1054

(57) ABSTRACT

An electronic device includes one or more processors and a cache that stores data entries. The electronic device transmits a request for translation of a first address to the cache. In accordance with a determination that the request is not satisfied by the data entries in the cache, the electronic device transmits the request to memory that is distinct from the cache, and receives data including a second address corresponding to the first address. In accordance with a determination that the data does not satisfy cache promotion criteria, the electronic device replaces an entry at a first priority level in the cache with the data. In accordance with a determination that the data satisfies the cache promotion criteria, the electronic device replaces an entry at a second priority level that is a higher priority level than the first priority level in the cache with the data including the second address.

### RELATED APPLICATIONS

This application claims priority to U.S. Provisional Patent Application No. 63/221,875, titled “Level-Aware Cache Replacement,” filed on Jul. 14, 2021, which is hereby incorporated by reference in its entirety.

### TECHNICAL FIELD

This application relates generally to microprocessor technology including, but not limited to, methods, systems, and devices for controlling cache replacement in a cache for a processing cluster having multiple processors.

### BACKGROUND

Caching improves computer performance by keeping recently used or often used data items (e.g., references to physical addresses of often used data) in caches that are faster to access compared to physical memory stores. As new information is fetched from physical memory stores or caches, caches are updated to store the newly fetched information to reflect current and/or anticipated data needs. However, caches are limited in their storage size and often require demotion of data currently stored in the caches to lower cache levels or eviction of data currently stored in the cache to a lower cache or memory store in order to make space for the newly fetched information. As such, it would be highly desirable to provide an electronic device or system that manages cache replacement efficiently for a processor cluster having multiple processors.

### SUMMARY

Various implementations of systems, methods and devices within the scope of the appended claims each have several aspects, no single one of which is solely responsible for the attributes described herein. Without limiting the scope of the appended claims, after considering this disclosure, and particularly after considering the section entitled “Detailed Description” one will understand how the aspects of some implementations are used to control cache replacement in a secondary memory cache that is connected to a plurality of processors (e.g., forming one or more processor clusters) based on a level-aware cache replacement policy. Such cache replacement improves cache hit rates in the secondary memory cache during a table-walk procedure including one-stage and two-stage table walks. In some implementations, the level-aware cache replacement policy defines a level of a table (e.g., within a table walk process) from which the cache entry is obtained or generated. In some implementations, the level-aware cache replacement policy determines whether data in a cache entry satisfies cache promotion criteria based on a level of a table (e.g., within a table walk process) from which the data is obtained. In some implementations, the level-aware cache replacement policy includes a first set of one or more cache management rules for cache entries that store data that satisfy cache promotion criteria, and a second set of one or more cache management rules for cache entries that store data that does not satisfy cache promotion criteria.

In accordance with some implementations, an electronic device includes a first processing cluster that includes one or more processors and a cache coupled to the one or more processors in the first processing cluster. The cache stores a plurality of data entries. The electronic device is configured to transmit an address translation request of a first address from the first processing cluster to the cache. In accordance with a determination that the address translation request is not satisfied by the data entries in the cache (e.g., the address translation request misses in the cache because the cache does not store the requested data), the electronic device transmits the address translation request to memory (e.g., a lower-level cache or system memory) that is distinct from the cache. In accordance with a determination that the data does not satisfy cache promotion criteria, the electronic device replaces an entry (e.g., a cache entry) at a first priority level (e.g., a first cache level) in the cache with the data. In accordance with a determination that the data satisfies the cache promotion criteria, the electronic device replaces an entry (e.g., a cache entry) at a second priority level (e.g., a first cache level) in the cache with the data including the second address. The second priority level is a higher priority level in the cache than the first priority level (e.g., the second cache level stores data that is more recently used than the first cache level). A method of controlling cache entry replacement in a cache is also described herein.

Other implementations and advantages may be apparent to those skilled in the art in light of the descriptions and drawings in this specification.

### BRIEF DESCRIPTION OF THE DRAWINGS

FIG. 1 is a block diagram of an example system module in a typical electronic device, in accordance with some implementations.

FIG. 2 is a block diagram of an example electronic device having one or more processing clusters, in accordance with some implementations.

FIG. 3A illustrates an example method of a table walk for fetching data from memory, in accordance with some implementations.

FIG. 3B illustrates an example of caching table walk outputs for increased speed in data fetching, in accordance with some implementations.

FIG. 4A illustrates an example method of a two-stage table walk for fetching data from memory, in accordance with some implementations.

FIG. 4B illustrates an example caching table walk outputs for increased speed in data fetching, in accordance with some implementations.

FIG. 5 illustrates levels in a cache, in accordance with some implementations.

FIGS. 6A-6D illustrate cache replacement policies for cache entries that store data that do not satisfy cache promotion criteria, in accordance with some implementations.

FIGS. 7A-7B illustrate cache replacement policies for cache entries that store data that satisfies cache promotion criteria, in accordance with some implementations.

FIGS. 8A-8C illustrate a flow chart of an example method of controlling cache entry replacement in a cache, in accordance with some implementations.

Like reference numerals refer to corresponding parts throughout the drawings.

### DESCRIPTION OF EMBODIMENTS

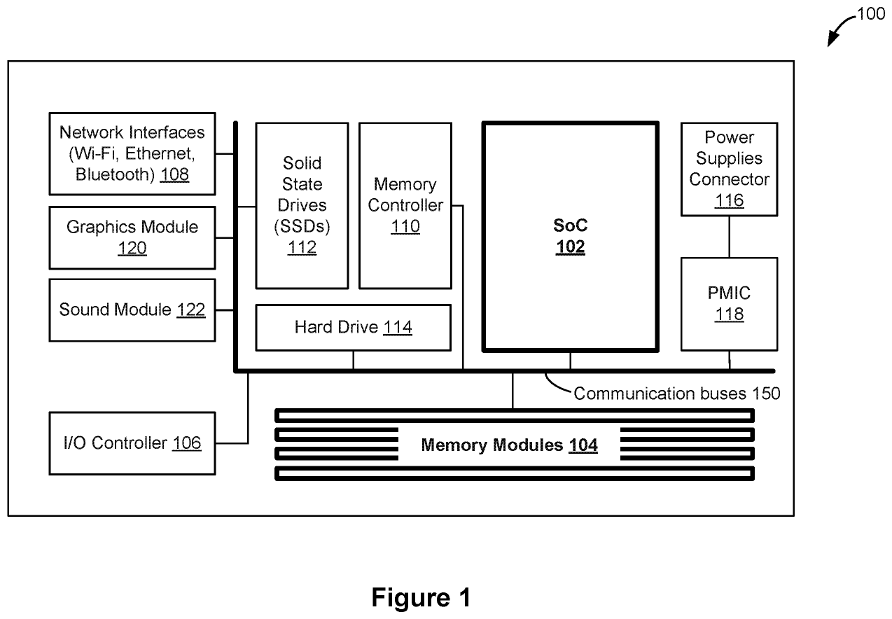

FIG. 1 is a block diagram of an example system module 100 in a typical electronic device in accordance with some implementations. System module 100 in this electronic device includes at least a system on a chip (SoC) 102, memory modules 104 for storing programs, instructions and data, an input/output (I/O) controller 106, one or more communication interfaces such as network interfaces 108, and one or more communication buses 150 for interconnecting these components. In some implementations, I/O controller 106 allows SoC 102 to communicate with an I/O device (e.g., a keyboard, a mouse or a track-pad) via a universal serial bus interface. In some implementations, network interfaces 108 includes one or more interfaces for Wi-Fi, Ethernet and Bluetooth networks, each allowing the electronic device to exchange data with an external source, e.g., a server or another electronic device. In some implementations, communication buses 150 include circuitry (sometimes called a chipset) that interconnects and controls communications among various system components included in system module 100.

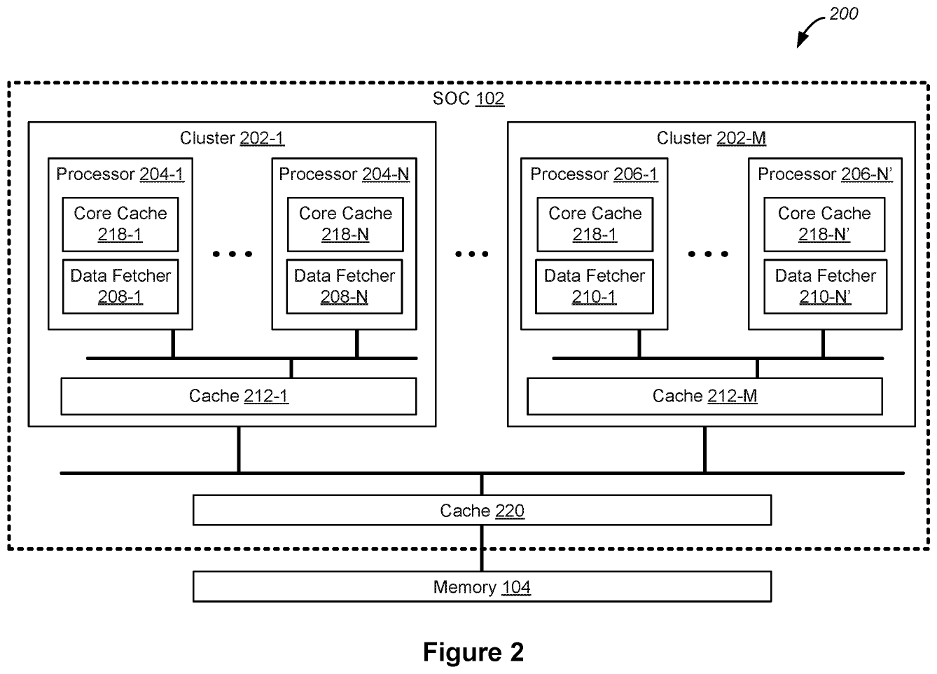

In some implementations, memory modules 104 (e.g., memory 104 in FIG. 2) include high-speed random access memory, such as DRAM, SRAM, DDR RAM or other random access solid state memory devices. In some implementations, memory modules 104 include non-volatile memory, such as one or more magnetic disk storage devices, optical disk storage devices, flash memory devices, or other non-volatile solid state storage devices. In some implementations, memory modules 104, or alternatively the non-volatile memory device(s) within memory modules 104, include a non-transitory computer readable storage medium. In some implementations, memory slots are reserved on system module 100 for receiving memory modules 104. Once inserted into the memory slots, memory modules 104 are integrated into system module 100.

In some implementations, system module 100 further includes one or more components selected from:
a memory controller 110 that controls communication between SoC 102 and memory components, including memory modules 104, in electronic device, including controlling memory management unit (MMU) line replacement (e.g., cache entry replacement, cache line replacement) in a cache in accordance with a cache replacement policy;
solid state drives (SSDs) 112 that apply integrated circuit assemblies to store data in the electronic device, and in many implementations, are based on NAND or NOR memory configurations;
a hard drive 114 that is a conventional data storage device used for storing and retrieving digital information based on electromechanical magnetic disks;
a power supply connector 116 that is electrically coupled to receive an external power supply;
power management integrated circuit (PMIC) 118 that modulates the received external power supply to other desired DC voltage levels, e.g., 5V, 3.3V or 1.8V, as required by various components or circuits (e.g., SoC 102) within electronic device;
a graphics module 120 that generates a feed of output images to one or more display devices according to their desirable image/video formats; and
a sound module 122 that facilitates the input and output of audio signals to and from the electronic device under control of computer programs.

It is noted that communication buses 150 also interconnect and control communications among various system components including components 110-122.

Further, one skilled in the art knows that other non-transitory computer readable storage media can be used, as new data storage technologies are developed for storing information in the non-transitory computer readable storage media in the memory modules 104 and in SSDs 112. These new non-transitory computer readable storage media include, but are not limited to, those manufactured from biological materials, nanowires, carbon nanotubes and individual molecules, even though the respective data storage technologies are currently under development and yet to be commercialized.

In some implementations, SoC 102 is implemented on an integrated circuit that integrates one or more microprocessors or central processing units, memory, input/output ports and secondary storage on a single substrate. SoC 102 is configured to receive one or more internal supply voltages provided by PMIC 118. In some implementations, both the SoC 102 and PMIC 118 are mounted on a main logic board, e.g., on two distinct areas of the main logic board, and electrically coupled to each other via conductive wires formed in the main logic board. As explained above, this arrangement introduces parasitic effects and electrical noise that could compromise performance of the SoC, e.g., cause a voltage drop at an internal voltage supply. Alternatively, in some implementations, SoC 102 and PMIC 118 are vertically arranged in an electronic device, such that they are electrically coupled to each other via electrical connections that are not formed in the main logic board. Such vertical arrangement of SoC 102 and PMIC 118 can reduce a length of electrical connections between SoC 102 and PMIC 118 and avoid performance degradation caused by the conductive wires of the main logic board. In some implementations, vertical arrangement of SoC 102 and PMIC 118 is facilitated in part by integration of thin film inductors in a limited space between SoC 102 and PMIC 118.

FIG. 2 is a block diagram of an example electronic device 200 having one or more processing clusters 202 (e.g., first processing cluster 202-1, Mth processing cluster 202-M), in accordance with some implementations. Electronic device 200 further includes a cache 220 and a memory 104 in addition to processing clusters 202. Cache 220 is coupled to processing clusters 202 on SOC 102, which is further coupled to memory 104 that is external to SOC 102. Each processing cluster 202 includes one or more processors 204 and a cluster cache 212. Cluster cache 212 is coupled to one or more processors 204, and maintains one or more request queues 214 for one or more processors 204. Each processor 204 further includes a respective data fetcher 208 to control cache fetching (including cache prefetching) associated with the respective processor 204. In some implementations, each processor 204 further includes a core cache 218 that is optionally split into an instruction cache and a data cache, and core cache 218 stores instructions and data that can be immediately executed by the respective processor 204.

In an example, first processing cluster 202-1 includes first processor 204-1, . . . , N-th processor 204-N, first cluster cache 212-1, where N is an integer greater than 1. First cluster cache 212-1 has one or more first request queues, and each first request queue includes a queue of demand requests and prefetch requests received from a subset of processors 204 of first processing cluster 202-1. In some embodiments, SOC 102 only includes a single processing cluster 202-1. Alternatively, in some embodiments, SOC 102 includes at least an additional processing cluster 202, e.g., M-th processing cluster 202-M. M-th processing cluster 202-M includes first processor 206-1, . . . , N′-th processor 206-N′, and M-th cluster cache 212-M, where N′ is an integer greater than 1 and M-th cluster cache 212-M has one or more M-th request queues.

In some implementations, the one or more processing clusters 202 are configured to provide a central processing unit for an electronic device and are associated with a hierarchy of caches. For example, the hierarchy of caches includes three levels that are distinguished based on their distinct operational speeds and sizes. For the purposes of this application, a reference to “the speed” of a memory (including a cache memory) relates to the time required to write data to or read data from the memory (e.g., a faster memory has shorter write and/or read times than a slower memory), and a reference to “the size” of a memory relates to the storage capacity of the memory (e.g., a smaller memory provides less storage space than a larger memory). The core cache 218, cluster cache 212, and cache 220 correspond to a first level (L1) cache, a second level (L2) cache, and a third level (L3) cache, respectively. Each core cache 218 holds instructions and data to be executed directly by a respective processor 204, and has the fastest operational speed and smallest size among the three levels of memory. For each processing cluster 202, the cluster cache 212 is slower operationally than the core cache 218 and bigger in size, and holds data that is more likely to be accessed by processors 204 of respective processing cluster 202. Cache 220 is shared by the plurality of processing clusters 202, and bigger in size and slower in speed than each core cache 218 and cluster cache 212. Each processing cluster 202 controls prefetches of instructions and data to core caches 218 and/or cluster cache 212. Each individual processor 204 further controls prefetches of instructions and data from respective cluster cache 212 into respective individual core cache 218.

In some implementations, a first cluster cache 212-1 of first processing cluster 202-1 is coupled to a single processor 204-1 in the same processing cluster, and not to any other processors (e.g., 204-N). In some implementations, first cluster cache 212-1 of first processing cluster 202-1 is coupled to a plurality of processors 204-1 and 204-N in the same processing cluster. In some implementations, first cluster cache 212-1 of first processing cluster 202-1 is coupled to the one or more processors 204 in the same processing cluster 202-1, and not to processors in any cluster other than the first processing cluster 202-1 (e.g., processors 206 in cluster 202-M). In such cases, first cluster cache 212-1 of first processing cluster 202-1 is sometimes referred to as a second-level cache (e.g., L2 cache).

In each processing cluster 202, each request queue optionally includes a queue of demand requests and prefetch requests received from a subset of processors 204 of respective processing cluster 202. Each data retrieval request received from respective processor 204 is distributed to one of the request queues associated with the respective processing cluster. In some implementations, a request queue receives only requests received from a specific processor 204. In some implementations, a request queue receives requests from more than one processor 204 in the processing cluster 202, allowing a request load to be balanced among the plurality of request queues. Specifically, in some situations, a request queue receives only one type of data retrieval requests (e.g., prefetch requests) from different processors 204 in the same processing cluster 202.

Each processing cluster 202 includes or is coupled to one or more data fetchers 208 in processors 204, and the data fetch requests (e.g., demand requests, prefetch requests) are generated and processed by one or more data fetchers 208. In some implementations, each processor 204 in processing cluster 202 includes or is coupled to a respective data fetcher 208. In some implementations, two or more of processors 204 in processing cluster 202 share the same data fetcher 208. A respective data fetcher 208 may include any of a demand fetcher for fetching data for demand requests and a prefetcher for fetching data for prefetch requests.

A data fetch request (including demand requests and prefetch requests) are received at a processor (e.g., processor 204-1) of a processing cluster 202. The data fetch request is an address translation request to retrieve data from memory (e.g., memory 104) that includes information for translating a virtual address into a physical address (e.g., to retrieve data that includes a virtual address to physical address translation or a virtual address to physical address mapping, which includes, for example, a page entry in a page table). A data fetcher of the processor (such as data fetcher 208-1 of processor 204-1) begins the data fetching process by querying a translation lookaside buffer (TLB) to see if a requested data 390 (e.g., the requested address translation) is stored in the TLB. In accordance with a determination that the requested data 390 (e.g., the requested address translation) is found in the TLB (e.g., a TLB “hit”), the data is retrieved from the TLB and passed onto the processor. In accordance with a determination that the requested data 390 (e.g., the requested address translation) is not found in the TLB (e.g., TLB “miss”) data fetcher 208 starts searching for requested data 390 in a core cache 218 associated the processor (e.g., core cache 218-1 associated with processor 204-1). In accordance with a determination that requested data 390 is not stored in core cache 218-1, data fetcher 208-1 queries cluster cache 212-1. In accordance with a determination that requested data 390 is not stored in cluster cache 212-1, data fetcher 208-1 queries cache 220, and in accordance with a determination that requested data 390 is not stored in cache 220, data fetcher 208-1 queries memory 104.

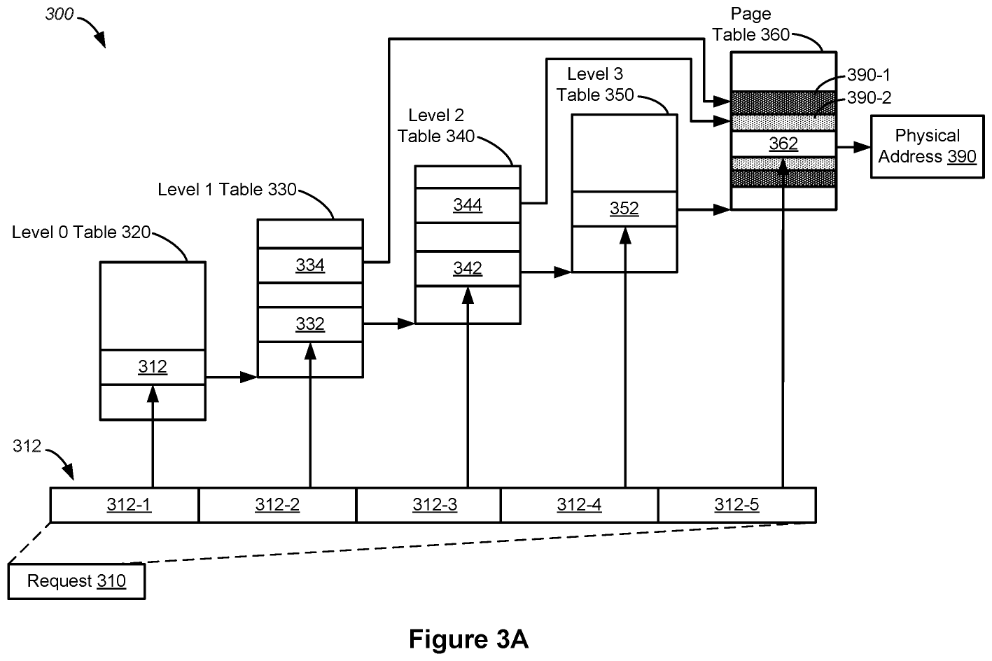

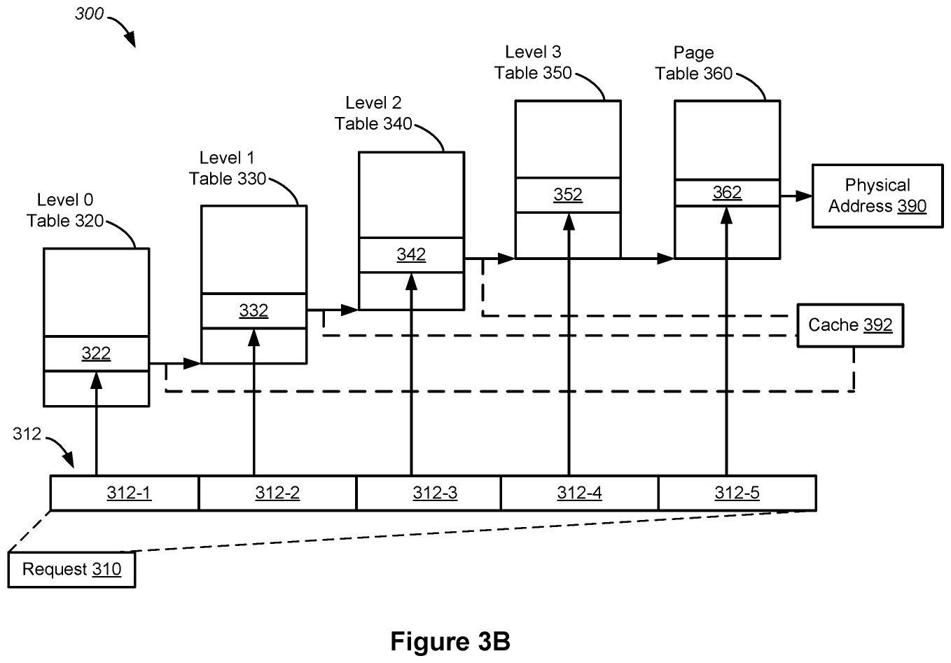

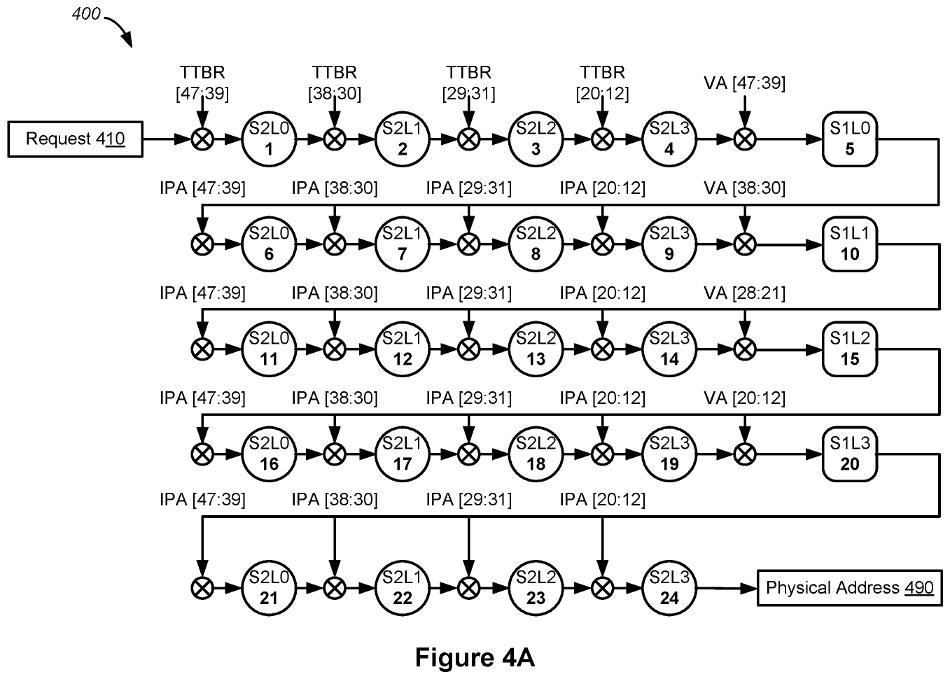

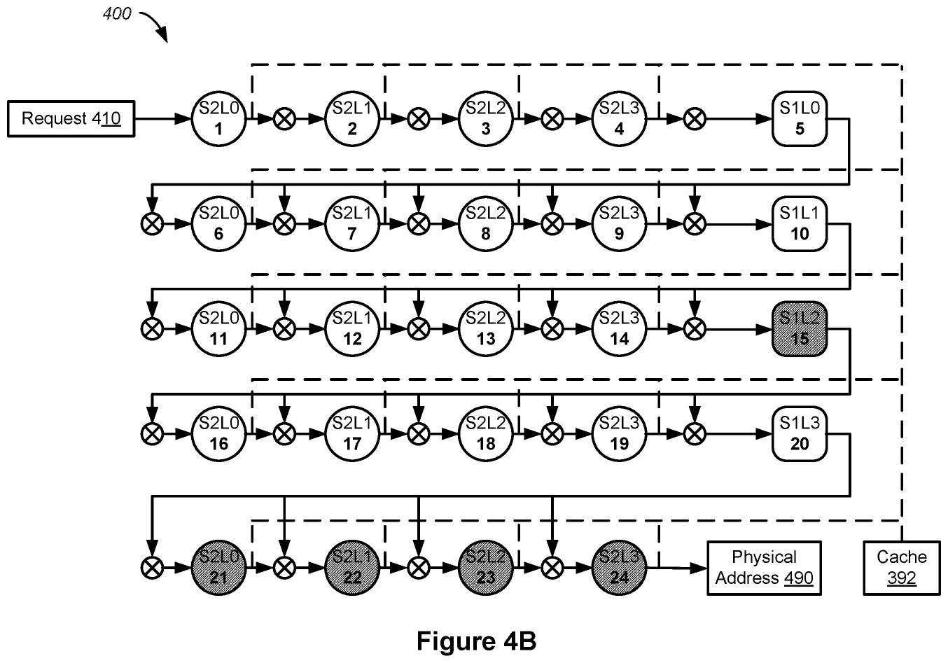

In order to determine whether or not the data is stored in a respective cache (e.g., any of cache 218, 212, and 220 shown in FIG. 2), data fetcher 208 performs a table walk process in the respective cache. In some implementations, the table walk process is a one-stage table walk process (e.g., single-stage table walk process), such as the table walk process shown in FIGS. 3A and 3B. In some implementations, the table walk process is a two-stage table walk process, such as the two-stage table walk process shown in FIGS. 4A and 4B.

FIG. 3A illustrates an example of a one-stage table walk process 300 for fetching data by a processing cluster 202 (e.g., by a data fetcher 208 of first processing cluster 202-1 of FIG. 2), in accordance with some implementations. In this example, address translation information (e.g., the page table) is stored in a multi-level hierarchy that includes at least one level 0 table, a plurality of level 1 tables, a plurality of level 2 tables, and a plurality of level 3 tables. A level 0 table stores page entries that include table descriptors that identify a specific level 1 table (e.g., a specific table of the plurality of level 1 tables, a first table of the plurality of level 1 tables), a level 1 table stores page entries that include table descriptors that identify a specific level 2 table (e.g., a specific table of the plurality of level 2 tables, a first table of the plurality of level 2 tables), a level 2 table stores page entries that include table descriptors that identify a specific level 3 table (e.g., a specific table of the plurality of level 3 tables, a first table of the plurality of level 3 tables), and a level 3 table stores page entries that include page descriptors that identify a specific page table in memory 104. Table walk process 300 begins at the level 0 table and continues until the requested data 390 stored in the page entry in memory 104 (e.g., the page table in memory 104) is identified.

A data fetch process begins with a processor (e.g., processor 204-1) of a processing cluster (e.g., processing cluster 202-1) receiving an address translation request 310 that includes a virtual address 312 to be translated. Virtual address 312 includes a translation table base register (TTBR), which identifies the level 0 table at which a data fetcher of the processor (e.g., data fetcher 208-1 of processor 204-1) can begin table walk process 300. Table walk process 300 is initiated in accordance with a determination that requested data 390 (e.g., data requested by address translation request 310) is not stored in the TLB (e.g., a TLB “miss”).

Data fetcher 208 begins table walk process 300 by identifying a first table descriptor 322 that is stored in a page table entry in the level 0 table 320. First table descriptor 322 includes information that identifies a level 1 table 330 (e.g., a specific level 1 table) for which data fetcher 208 can query to continue table walk process 300. In some implementations, at least a portion (e.g., a first portion 312-1) of virtual address 312 is used to find first table descriptor 322 in level 0 table 320. For example, a first portion 312-1 of virtual address 312 may include a reference to the page table entry in level 0 table 320 that stores first table descriptor 322.

Data fetcher 208 identifies level 1 table 330 based on first table descriptor 322 obtained (e.g., output) from level 0 table 320, and identifies a second table descriptor 332 that is stored in a page table entry in level 1 table 330. Second table descriptor 332 includes information that identifies a level 2 table 340 (e.g., a specific level 2 table) for which data fetcher 208 can query to continue table walk process 300. In some implementations, at least a portion (e.g., a second portion 312-2) of virtual address 312 is used to find second table descriptor 332 in level 1 table 330. For example, a second portion 312-2 of virtual address 312 may include a reference to the page table entry in level 1 table 330 that stores second table descriptor 332. In some implementations, in addition to providing second table descriptor 332, level 1 table 330 also provides a first block descriptor 334 that identifies a first contiguous portion 390-1 within memory 104, e.g., a first contiguous portion 390-1 in memory 104 within which requested data 390 is stored.

Data fetcher 208 identifies level 2 table 340 based on second table descriptor 332 obtained from level 1 table 330, and identifies a third table descriptor 342 that is stored in a page table entry in level 2 table 340. Third table descriptor 342 includes information that identifies a level 3 table 350 (e.g., a specific level 3 table) for which data fetcher 208 can query to continue table walk process 300. In some implementations, at least a portion (e.g., a third portion 312-3) of virtual address 312 is used to find third table descriptor 342 in level 2 table 340. For example, a third portion 312-3 of virtual address 312 may include a reference to the page table entry in level 2 table 340 that stores third table descriptor 342. In some implementations, in addition to providing (e.g., outputting) third table descriptor 342, level 2 table 330 also provides a second block descriptor 344 that identifies a second contiguous portion 390-2 within memory 104 (e.g., a second contiguous portion 390-2 in memory 104 within which requested data 390 (e.g., requested address translation) is stored). In some implementations, second contiguous portion 390-2 in memory 104 includes a smaller portion of memory 104 compared to first contiguous portion 390-1 in memory 104, and first contiguous portion 390-1 in memory 104 includes second contiguous portion 390-2 in memory 104. For example, first contiguous portion 390-1 in memory 104 includes 16 MB of space in memory 104, and second contiguous portion 390-2 in memory 104 includes 32 KB of space in the memory.

Data fetcher 208 identifies level 3 table 350 based on third table descriptor 342 obtained (e.g., output) from level 2 table 340, and identifies a page descriptor 352 that is stored in a page table entry in level 3 table 350. Page descriptor 352 includes information that identifies a page table 360 in memory 104 for which data fetcher 208 can query to continue table walk process 300. In some implementations, at least a portion (e.g., a fourth portion 312-4) of virtual address 312 is used to find page descriptor 352 in memory 104. For example, a fourth portion 312-4 of virtual address 312 may include a reference to the page table entry in level 3 table 350 that stores page descriptor 352.

Data fetcher 208 queries page table 360 in memory 104, as identified by page descriptor 352 output from level 3 table 350, to find a page entry 362 that stores requested data 390 (e.g., stores the requested virtual address to physical address translation). In some implementations, at least a portion (e.g., a fifth portion 312-5) of virtual address 312 is used to find page entry 362 in page table 360. For example, a fifth portion 312-5 of virtual address 312 may include a reference to the byte on page table 360 that stores requested data 390.

Thus, using table walk process 300, a data fetcher of a processor (e.g., data fetcher 208-1 of processor 204-1) is able to obtain requested data 390 (e.g., requested address translation 390, physical address 390 corresponding to request 310) and pass requested data 390 to the processor. However, the table walk process introduces latency into system operations. Thus, in some embodiments, outputs from a table walk process are stored in a cache to speed up the data fetching process.

FIG. 3B illustrates an example of caching outputs from the table walk process to increase data fetching speed, in accordance with some implementations. Table descriptors 322, 332, and 342 output from level 0 table 320, level 1 table 330, and level 2 table 350, respectively, can be stored in a cache 392 such that future data requests for the same data (e.g., for the same address translation) can be quickly retrieved from cache 392, allowing data fetcher 208 to skip at least a portion of table walk process 300. Cache 392 may correspond to any of cache 218, cache 212, and cache 220. In some implementations, the table walk outputs are stored in cache 212, which is the highest level cache shared by a plurality of processing cores 204.

For example, in the case where third table descriptor 342 is stored in cache 392, in response to a new request for an address translation for virtual address 312 (e.g., a request for physical address 390), data fetcher 208 is able to skip portions of table walk process 300 corresponding to querying level 0 table 320, level 1 table 330, and level 2 table 340. Instead, data fetcher 208 can directly obtain third table descriptor 342 since it is stored in cache 392. In practice, cache 392 stores the physical address 390, thereby further increasing the data fetch speed and reducing latency since data fetcher 208 can directly retrieve the requested data (e.g., physical address 390) from cache 392 and thus, does not have to perform table walk process 300. In some situations, table walk process 300 is entirely skipped.

In another example, in the case where second table descriptor 332 is stored in cache 392, in response to new request for an address translation for virtual address 312 (e.g., a request for physical address 390), data fetcher 208 is able to skip querying level 0 table 320 and level 1 table 330. Instead, data fetcher 208 can directly obtain second table descriptor 332 since it is stored in cache 392 and complete the table walk process by using second table descriptor 332 to directly identify level 2 table 340 (e.g., without having to query level 0 table 320 and level 1 table 330). Data fetcher 208 completes table walk process 300 by traversing level 2 table 340, level 3 table 350, and page table 360 to retrieve requested data 390 (e.g., physical address 390). Thus, by caching outputs from a table walk process 300, data fetcher 208 can handle TLB “misses” much faster thereby improving data fetching speed reducing latency in system operations.

Further, in some embodiments, table walk outputs are stored in cache 392, and particularly, table walk outputs from level 2 table 340 are stored over other outputs from the table walk process since outputs from level 2 table 340 provide the biggest shortcut in the table walk process. In practice, cache 392 directly stores requested data 390 (e.g., physical address 390) for level 2 table 340. Storing table walk outputs from level 2 table 340 directly returns requested data 390 without requiring data fetcher 208 to perform a table walk. In some implementations, cache 392 stores page descriptor 352 for level 2 table 340.

In some implementations, cache replacement policies include different policies for cache entries that store data that satisfy cache promotion criteria (also referred to herein as “preferential cache entries”) versus cache entries that store data that does not satisfy cache promotion criteria (also referred to herein as “non-preferential cache entries”). In some implementations, a data satisfies cache promotion criteria when the data corresponds to outputs from level 2 table 340 (e.g., cache entries that store outputs from level 2 table 340 are preferential cache entries). Thus, if an address translation for virtual address 312 (e.g., physical address 390) is often requested, storing physical address 390 in the form of a preferential cache entry that stores data output from level 2 table 340 in cache 392 (e.g., caching the output from level 2 table 340) will result in significantly reduced latency in data fetching.

Similar use of table walk caches can also be employed in two-stage table walks, which are used in virtual machines that require translation of a virtual address to an intermediate physical address (IPA) and translation of the IPA to a physical address.

FIG. 4A illustrates an example method of implementing a two-stage table walk process 400 for fetching data from memory 104, in accordance with some implementations. The two-stage table walk process 400 includes a stage 1 table walk (also called a guest table walk) and a stage 2 table walk. The stage 1 table walk is similar to the one-stage table walk process 300 shown in FIGS. 3A and 3B, such that the guest table walk first identifies and queries a stage 1 level 0 table (e.g., S1L0) to find a table descriptor that identifies a stage 1 level 1 table (e.g., S1L1). Data fetcher 208 then uses a table descriptor obtained from (e.g., output from) the stage 1 level 1 table to identify and query a stage 1 level 2 table (e.g., S1L2) to find a table descriptor that identifies a stage 1 level 3 table (e.g., S1L3). Data fetcher 208 then uses a page descriptor obtained from (e.g., output from) the stage 1 level 3 table to identify and query a page table in memory 104 to find the requested data (e.g., requested address translation, requested physical address). In contrast to one-stage table walk process 300 shown in FIGS. 3A and 3B, each stage 1 table (e.g., tables S1L0, S1L1, S1L2, and S1L3) outputs an IPA that is used in a second stage portion of the two-stage table walk to identify the next table in the first stage (e.g., table S1L0 outputs an IPA that points to a stage 2 level 0 table and a second stage table walk is performed to identify table S1L1).

Request 410 (e.g., request for an address translation) includes a virtual address that includes a translation table base register (TTBR). In contrast to one-stage table walk process 300 shown in FIGS. 3A and 3B, the TTBR identifies a stage 2 level 0 table (e.g., SOLO, represented by block “1”) at which a data fetcher of the processor (e.g., data fetcher 208-1 of processor 204-1) begins the two-stage table walk process 400.

Two-stage table walk process 400 starts by performing the second stage of table walk process. During the second stage of table walk process 400, data fetcher 208 queries the stage 2 tables (e.g., S2L0, S2L1, S2L2, and S2L3 tables) to find descriptors (e.g., IPAs) that identify which stage 1 tables (e.g., S1L0, S1L1, S1L2, and S1L3 tables) to query during the first stage of table walk process 400. Data fetcher 208 starts by performing the second stage of table walk process 400, starting at a stage 2 level 0 table (e.g., S2L0, represented by block “1”) which provides a descriptor that identifies a stage 2 level 1 table (e.g., S2L1, represented by block “2”), then progressing to stage 2 level 1 table (e.g., S2L1, represented by block “2”) which provides a descriptor that identifies a stage 2 level 2 table (e.g., S2L2, represented by block “3”), then to stage 2 level 2 table which provides a descriptor that identifies a stage 2 level 3 table (e.g., S2L3, represented by block “4”), then to stage 2 level 3 table which provides a descriptor that identifies a stage 1 level 0 table (e.g., S1L0). Once the S1L1 table is identified, data fetcher 208 can query S1L1 table for an IPA that identifies a stage 2 level 0 table in the next row (e.g., S2L0, represented by block “6”), and data fetcher 208 performs another second stage of table walk process 400 to identify a stage 1 level 1 table in the second row (e.g., S1L1, represented by block “7”). This process is repeated until data fetcher 208 identifies S1L3 table. Data fetcher 208 then queries S1L3 table to identify a stage 2 level 0 table in the fifth row (e.g., S2L0, represented by block “21”) and performs a second stage of table walk 400 to identify until a stage 2 level 3 table (e.g., S2L3, represented by block “24”) is identified. Data fetcher then queries the stage 2 level 3 table (e.g., S2L3, represented by block “24”) to find a page descriptor that points to a page table in memory 104 where requested data 490 (e.g., requested address translation 490, requested physical address 490) is stored.

The two-stage table walk process 400 shown in FIG. 4A can be sped by storing the store outputs (e.g., caching the outputs, such as IPAs, table descriptors, page descriptors, and physical addresses) obtained during two-stage table walk process 400. For example, outputs from any of a stage 2 table (e.g., S2L0, S2L1, S2L2, and S2L3 in any row) and a stage 1 table (e.g., S1L0, S1L1, and S1L3) can be stored in a cache 392.

FIG. 4B illustrates an example caching table walk outputs for increased speed in data fetching, in accordance with some implementations. A cache (e.g., cache 392, 218, 212, or 220) stores an output from the tables involved in table walk process 400, e.g., stage 2 tables S2L0, S2L1, S2L2, and S2L3 in any row, stage 1 tables S1L0, S1L1, and S1L3. In response to subsequent requests related to previously requested physical addresses, these physical addresses are retrieved directly from the cache that stores the outputs from table walk process 400, thereby allowing data fetcher 208 to skip at least a portion or all of two-stage table walk process 400. In an example, cache 212 is the upper-most cache that is shared by a plurality of processing cores 204, and is applied to store the outputs from table walk process 400.

For example, in the case where an output from an S1L1 table is stored in cache 392, in response to a new request for physical address 490, data fetcher 208 is configured to skip the second stage of the table walk for the first row of S2L0 table (block “1”), S2L1 table (block “2”), S2L2 table (block “3”), and S2L3 table (blocks “4”) and directly start the table walk at the second stage of the table walk for the second row of stage 2 tables including S2L0 table (block “6”), S2L1 table (block “7”), S2L2 table (block “8”), and S2L3 table (blocks “9”).

In another example, in the case where an output from S1L2 table is stored in cache 392, in response to a new request for physical address 490, data fetcher 208 is able to skip querying the first three rows of the stage 2 tables and skip S1L0, S1L1, and S1L2 tables in the table walk. Data fetcher 208 can use the cached output to identify the stage 2 level 0 table in the fourth row (e.g., S2L0 (block “16”)) and perform the two-stage table walk process 400 until physical address 490 is retrieved (e.g., obtained, acquired, identified).

In yet another example, in the case where an output from any of the stage 2 tables in the fifth row (e.g., S2L0, S2L1, S2L2 and S2L3 tables represented by blocks “21,” “22,” “23,” and “24,” respectively) is stored in cache 392, in response to a new request for the physical address 490, data fetcher 208 is able to skip the stage 1 table walk entirely and skip the first four rows of the second stage of the table walk, and directly start the table walk at the fifth row of stage 2 tables. In some implementations, cache 392 stores physical address 490 and does not store descriptors when caching outputs from stage 2 tables S2L0, S2L1, S2L2 and S2L3 in the fifth row, thereby further increasing the data fetch speed and reducing latency.

In some implementations, all outputs from two-stage table walk process 400 are stored in cache 392. Cache 392 stores table walk outputs from the stage 1 level 2 table (e.g., S1L2, represented by block “15” and shown with a patterned fill) and the stage 2 tables in the fifth row (e.g., S2L0, S2L1, S2L2 and S2L3 tables represented by blocks “21,” “22,” “23,” and “24,” respectively, each shown with a patterned fill). Those outputs provide the biggest shortcut (e.g., the most steps skipped) in two-stage table walk process 400. Thus, if the physical address 490 is frequently requested, storing table walk outputs from the stage 1 level 2 table (e.g., S1L2, represented by block “15”) and the stage 2 tables in the fifth row (e.g., S2L0, S2L1, S2L2 and S2L3 tables represented by blocks “21,” “22,” “23,” and “24,” respectively) in cache 392 reduces a corresponding latency and improves data fetching speeds. In some implementations, cache replacement policies include different policies for cache entries (e.g., preferential cache entries) storing data that satisfies cache promotion criteria and cache entries (e.g., non-preferential cache entries) storing data that does not satisfy cache promotion criteria. In such cases, data satisfies cache promotion criteria when the data corresponds to an output from any of the stage 1 level 2 table (e.g., S1L2, represented by block “15” and shown with a patterned fill) and the stage 2 tables S2L0, S2L1, S2L2 and S2L3 in the fifth row (e.g., tables represented by blocks “21,” “22,” “23,” and “24,” respectively, each shown with a patterned fill).

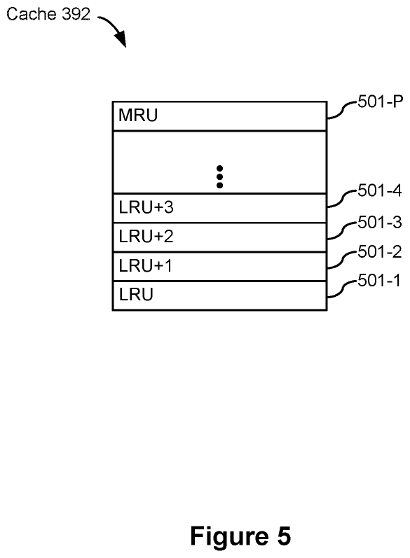

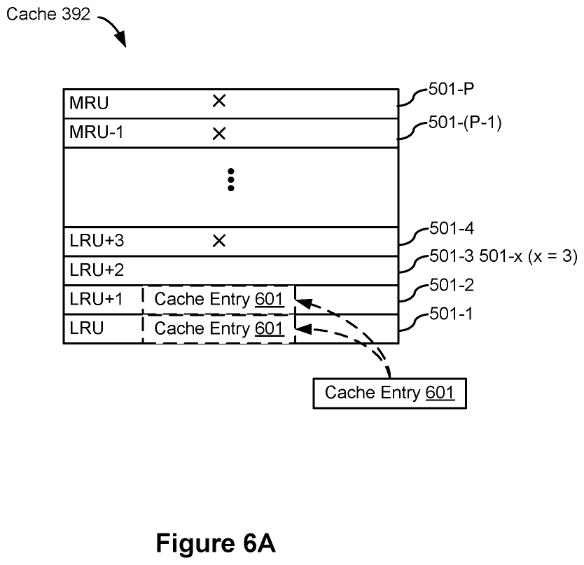

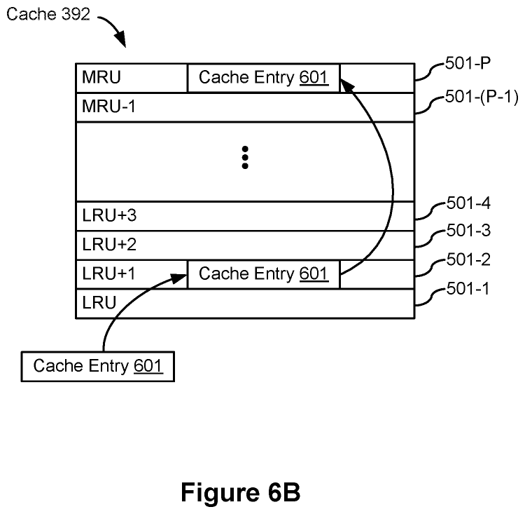

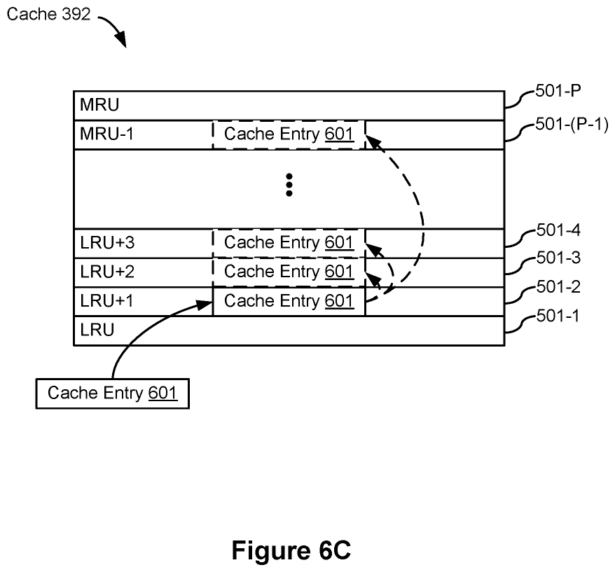

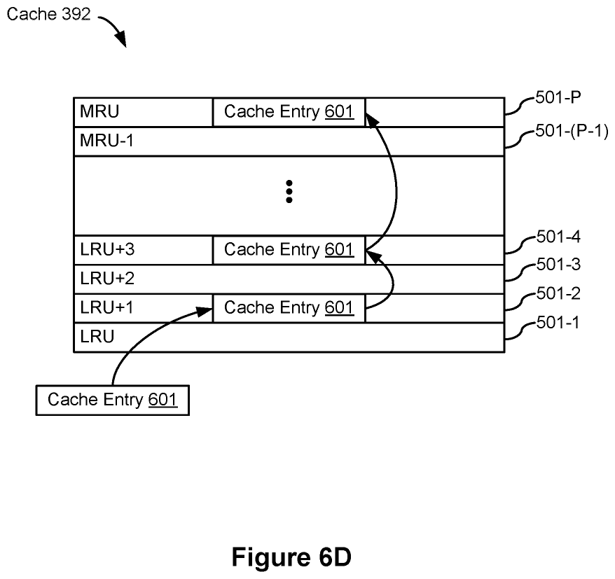

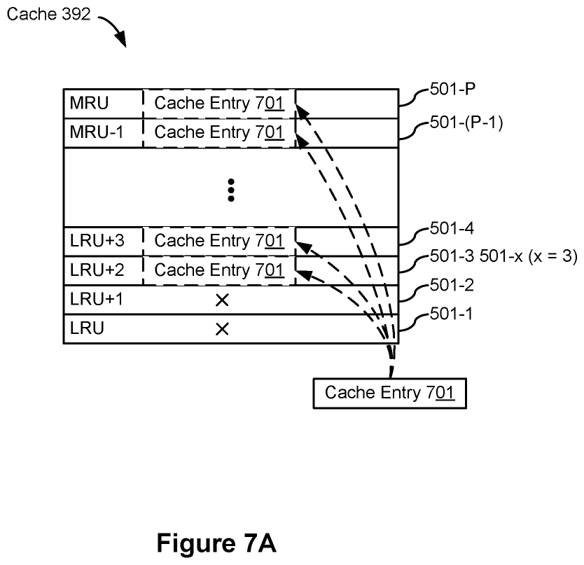

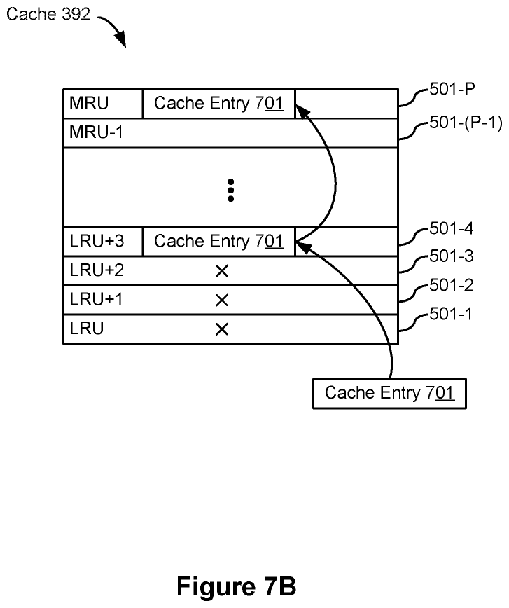

In some implementations, a new cache entry is added to cache 392. Examples of the new cache entry optionally include, and are not limited to, a new cache line and an MMU line that stores table walk outputs including physical address translations, table descriptors, and page descriptors. A cache entry within cache 392 is removed to make space for the new cache entry. Cache 392 relies on a cache replacement policy to determine where in cache 392 the new cache line is stored, e.g., where in cache 392 to insert the new cache line, at what level in cache 392 to insert the new cache line. The cache replacement policy is also used by cache 392 to determine which cache entry in cache 392 is replaced, demoted to a lower cache line, or evicted to make space for the new cache line. In some implementations, the cache entry selected for replacement, demotion, or eviction is called a “victim.” More details regarding cache lines in a cache are discussed below with respect to FIG. 5, and more details regarding a cache replacement policy are discussed below with respect to FIGS. 6A-6D and 7A-7B.

FIG. 5 illustrates cache lines 501 (e.g., cache lines 501-1 through 501-P, also referred to herein as “cache levels”) in a cache 392, in accordance with some implementations. Cache 392 may correspond to any of caches 218, 212, and 220 (shown in FIG. 2). Cache 392 includes N number of cache lines 501, with N being any integer number. For example, an 8-way cache includes 8 cache lines (e.g., N=8). Cache lines 501 are ordered such that cache line 501-1 is the lowest cache line and cache line 501-P is the highest cache line. Thus, cache line 502-2 is higher than first cache line 501-1 and lower than cache line 501-3. In some embodiments, as shown, cache lines 501 are organized from most recently used (MRU) (e.g., most recently accessed) to least recently used (LRU) (e.g., least recently accessed). Thus, a cache entry stored at MRU cache line 501-P is more recently used (e.g., more recently accessed, more recently requested by a processor) than a cache entry stored at LRU+1 cache line 501-2.

In some implementations, as shown, cache 392 is organized based on how recently a cache entry (e.g., the data in the cache entry) was accessed. In such cases, cache entries of cache 392 stores data (e.g., address translation) as well as a tag corresponding to the data. The tag includes one or more bits that indicates how recently the data was used (e.g., accessed, requested). For example, data is stored in a first cache entry that is stored at LRU+1 cache line 502-2 and requested and thus, a tag corresponding to the first data is updated to indicate that the data was recently accessed. In some embodiments, in response to receiving a request for the first data, the first cache entry (which stores the first data) is promoted to a higher cache line. For example, the first cache entry is moved to MRU cache line 501-P or to LRU+2 cache line 501-3. Which cache line 501 in cache 392 the first cache entry is moved to depends on the cache replacement policy of the cache. In response to promoting the first cache entry to a new cache line, all cache lines below the new cache line are updated in accordance with promotion of the first data. For example, if the first cache entry is promoted from LRU+1 cache line 501-2 to LRU+3 cache line 501-4, cache lines 501-1 through 501-3 are updated. For example, data previously stored in cache line 501-4 is demoted to cache line 501-3 so that the first cache entry can be stored at cache line 501-4, data previously stored in cache line 501-3 is demoted to cache line 501-2, data previously stored in cache line 501-2 is demoted to cache line 501-1, data previously stored in cache line 501-1 is evited from cache 392, and cache lines above 501-4 are not affected (e.g., MRU cache line 501-P is not affected as long as N>4). In another example, data previously stored in cache line 501-4 is demoted to cache line 501-3 so that the first cache entry can be stored at cache line 501-4 and data previously stored in cache line 501-3 is evicted out of the cache. In yet another example, data previously stored in cache line 501-4 is evicted out of the cache.

In some embodiments, one of cache lines 501 in cache 392 is selected to store a new cache entry. In some implementations, one of cache entries currently stored in cache 392 is selected to be replaced when a new cache is added to cache 392. In some embodiments, one of cache lines 501 in cache 392 is selected to receive a cache entry (that is already stored in cache 392) to be moved in response to a request for data from the cache entry.

In some implementations, a cache replacement policy includes a first set of one or more rules for cache entries (e.g., preferential cache entries) storing data that satisfies cache promotion criteria and a second set of one or more rules, which differ from the first set of one or more rules, for cache entries (e.g., non-preferential cache entries) storing data that does not satisfy cache promotion criteria. In such cases, implementing the cache replacement policy includes storing an indicator (e.g., marker, tag) in cache entries storing data that satisfy the cache promotion criteria (e.g., in preferential cache entries) that indicates (e.g., identifies, determines) that data stored in the cache entry satisfies the cache promotion criteria. In some implementations, implementing the cache replacement policy includes storing, in a cache entry, an indicator an indicator (e.g., marker, tag) that indicates whether or not data stored in the cache entry satisfies the cache promotion criteria (e.g., whether the cache entry is a preferential cache entry or a non-preferential cache entry). The inclusion of different sets of rules for preferential cache entries versus non-preferential cache entries can be useful in maintaining useful (e.g., relevant) information in a cache. For example, when storing outputs from a table walk process in a cache, the cache stores cache entries that store physical addresses over cache entries that store outputs (e.g., table walk descriptors) that do not provide as big of a shortcut in the table walk process. In another example, the cache stores cache entries that store physical addresses at high cache lines in order to provide a longer lifetime for the cache entry in the cache compared to storing the cache entry at a lower cache line in the cache. Thus, utilizing a cache replacement policy that handles preferential cache entries differently from non-preferential cache entries can lead to more efficient cache management.

FIGS. 6A-6D and 7A-7B illustrate a replacement policy for a cache 392, in accordance with some implementations. Cache 392 may correspond to any of caches 218, 212, and 220 (shown in FIG. 2). In some implementations, cache 392 corresponds to a level 2 cache (e.g., a secondary cache, cache 212). In some implementations, memory controller 110 (shown in FIG. 1) is configured to execute cache replacement policies when adding a new cache entry to the cache, replacing an existing cache entry from the cache, and reorganizing cache lines (including promoting an existing cache entry in the cache to a higher cache line and/or demoting an existing cache entry in the cache to a lower cache line). A cache entry includes data (such as a physical address translation, an intermediate address translation, a block descriptor, or a page descriptor) and a tag that includes one or more indicators regarding the cache entry or the data stored in the cache entry. In some implementations, a tag corresponding to a cache entry may include (e.g., bits in a tag portion of a cache entry include) information regarding any of: (i) whether the cache entry corresponds to a prefetch request or a demand request, (ii) whether or not data in the cache entry satisfies cache promotion criteria (e.g., whether the cache entry is a preferential cache entry or a non-preferential cache entry), (iii) whether or not the cache entry has seen reuse while stored in the cache. For example, a tag may include a plurality of bits. In some implementations, the cache replacement policy handles a cache entry based on the information stored in the tag corresponding to the cache entry.

In some implementations, the cache replacement policy biases away from selecting preferential cache entries as victims (e.g., memory controller 110 will select a non-preferential cache entry for replacement before selecting a non-preferential cache entry for replacement regardless of which cache line(s) the preferential cache entry and the non-preferential cache entry are stored).

FIGS. 6A-6D illustrate cache replacement policies for cache entries (e.g., non-preferential cache entries) that store data that does not satisfy cache promotion criteria, in accordance with some implementations. Data stored in cache entry 601 does not satisfy cache promotion criteria and thus, cache entry 601 is a non-preferential cache entry (e.g., non-preferential cache line, non-preferential MMU line). Cache entry 601 includes a tag having one or more bits that indicate that data stored in cache entry 601 does not satisfy cache promotion criteria.

Referring to FIG. 6A, in accordance with a determination that a data fetcher (such as data fetcher 208) performs a table walk process to retrieve data from memory 104 in response to a first request (e.g., prefetch request or demand request) for the data, memory controller 110 receives instructions to store the data as a non-preferential cache entry 601 in cache 392 (e.g., add non-preferential cache entry 601 to cache 392). In accordance with cache entry 601 being a non-preferential cache entry, memory controller 110 adds non-preferential cache entry 601 at a cache line 501 that is below a pre-determined cache line 501-x (e.g., a threshold cache line 501-x, a predefined cache line 501-x). For example, if x=3, then memory controller 110 stores non-preferential cache entry 601 to cache 392 at LRU cache line 501-1 or LRU+1 cache line 501-2 (e.g., such that non-preferential cache entry 601 is stored at LRU cache line 501-1 or LRU+1 cache line 501-2 of cache 392). Cache 392 stores non-preferential cache entry 601 at the selected cache line (in this example, LRU+1 cache line 501-2) until memory controller 110 selects cache entry 601 as a victim for replacement from cache 392 (e.g., to make space for a new cache entry), until cache entry 601 is moved (e.g., demoted) to a lower cache line (e.g., LRU cache line 501-1) as new cache entries are added to cache 392 over time and cache entry 601 becomes older (e.g., less recently used), until cache entry 601 is evicted from cache 392, or until another request (e.g., prefetch request or demand request) for data stored in non-preferential cache entry 601 is received by a processor that is in communication with cache 392 (e.g., until any of processors 204-1 through 204-N of processing cluster 202-1 that is in communication with cache 212-1 receives a request for data stored in non-preferential cache entry 601).

In accordance with a determination that non-preferential cache entry 601 is selected for replacement before a request for data stored in non-preferential cache entry 601 is received at a processor that is in communication with cache 392, memory controller 110 demotes non-preferential cache entry 601 to a lower cache line in cache 392 or evicts cache entry 601 (e.g., cache entry 601 is no longer stored at cache 392) to make space for anew cache entry.

FIGS. 6B and 6C illustrate promotion of non-preferential cache entry 601 in accordance with a determination that a second request (e.g., subsequent to and distinct from the first request) for data stored in non-preferential cache entry 601 is received at a processor that is in communication with cache 392 while non-preferential cache entry 601 is stored in cache 392 (regardless of which cache line 501 cache entry 601 is stored at).

Referring to FIG. 6B, in accordance with a determination that the second request is a demand request, data fetcher passes data stored in non-preferential cache entry 601 to the processor (e.g., data fetcher 208 passes data stored in non-preferential cache entry 601 to processor 204-1) and memory controller 110 promotes non-preferential cache entry 601 to be stored at the highest cache line (e.g., MRU cache line 501-P), thereby increasing (e.g., maximizing) a lifetime of non-preferential cache entry 601 in cache 392. In some implementations, in response to receiving the second request for data stored in non-preferential cache entry 601, the tag associated with data stored in non-preferential cache entry 601 is updated to indicate that cache entry 601 has seen re-use (e.g., cache entry 601 was accessed while stored in cache 392). In some implementations, in response to receiving the second request for data stored in non-preferential cache entry 601 and in accordance with a determination that the second request is a demand request, the tag associated with data stored in non-preferential cache entry 601 is updated to indicate that cache entry 601 corresponds to a demand request.

Referring to FIG. 6C, in accordance with a determination that the second request is a prefetch request, the data fetcher passes data stored in non-preferential cache entry 601 to the processor (e.g., data fetcher 208 passes data stored in non-preferential cache entry 601 to processor 204-1) and memory controller 110 promotes non-preferential cache entry 601 to be stored at a cache line (e.g., any of cache lines 501-3 through 501-P) that is higher than a cache line at which non-preferential cache entry 601 is currently stored, thereby increasing the lifetime of non-preferential cache entry 601 in cache 392. For example, if non-preferential cache entry 601 is stored at LRU+1 cache line 501-2 when the second request is received, memory controller 110 may promote non-preferential cache entry 601 to any of cache lines 501-3 through 501-P. In another example, if non-preferential cache entry 601 is demoted from LRU+1 cache line 501-2 at some point during its lifetime in cache 392 and is stored at LRU cache line 501-1 when the second request is received, memory controller 110 may promote non-preferential cache entry 601 to any of cache lines 501-2 through 501-P. In some implementations, memory controller 110 promotes non-preferential cache entry 601 to be stored at a cache line (e.g., any of cache lines 501-3 through 501-(P−1)) that is higher than a cache line at which non-preferential cache entry 601 is currently stored other than the highest cache line (e.g., MRU cache line 501-P).

In some implementations, in response to receiving the second request for data stored in non-preferential cache entry 601, the tag associated with data stored in the non-preferential cache entry 601 is updated to indicate that cache entry 601 has seen re-use (e.g., cache entry 601 was accessed while stored in cache 392). In some implementations, in response to receiving the second request for data stored in non-preferential cache entry 601 and in accordance with a determination that the second request is a prefetch request, the tag associated with data stored in non-preferential cache entry 601 is updated to indicate that cache entry 601 corresponds to a prefetch request.

Referring to FIG. 6D, in accordance with a determination that a third request (e.g., subsequent to and distinct from each of the first request and the second request) for data stored in non-preferential cache entry 601 is received at a processor that is in communication with cache 392 while non-preferential cache entry 601 is stored in cache 392 (regardless of which cache line 501 cache entry 601 is stored at), the data fetcher passes data stored in non-preferential cache entry 601 to the processor (e.g., data fetcher 208 passes data stored in non-preferential cache entry 601 to processor 204-1) and memory controller 110 promotes non-preferential cache entry 601 to be stored at the highest cache line (e.g., MRU cache line 501-P), thereby increasing (e.g., maximizing) a lifetime of non-preferential cache entry 601 in cache 392. In the example shown in FIG. 6D, memory controller 110 promotes non-preferential cache entry 601 to be stored in cache 392 at LRU+3 cache line 501-4 in response to the second request, and memory controller 110 promotes non-preferential cache entry 601 to be stored in cache 392 at MRU cache line 501-P in response to the third request.

In some implementations, in response to receiving the third request for data stored in non-preferential cache entry 601, the tag associated with data stored in non-preferential cache entry 601 is updated to indicate that cache entry 601 has seen multiple re-uses (e.g., cache entry 601 was accessed at least twice while stored in cache 392). In some implementations, the tag associated with non-preferential cache entry 601 is updated to indicate the number of times cache entry 601 has been accessed while stored in cache 392 (e.g., the tag indicates that cache entry 601 was accessed twice while stored in cache 392).

In some implementations, in response to subsequent requests (e.g., each subsequent request after the third request) for data stored in cache entry 601, memory controller 110 promotes cache entry 601 to MRU cache line 501-P if cache entry 601 is stored in cache 392 at a cache line that is different from MRU cache line 501-P. In some implementations, in response to each subsequent request, the tag associated with cache entry 601 is updated to indicate the number of times cache entry 601 has been accessed while stored in cache 392.

FIGS. 7A-7B illustrate cache replacement policies of a cache 392 that stores data that satisfies cache promotion criteria, in accordance with some implementations. Data stored in cache entry 701 satisfies the cache promotion criteria and thus, cache entry 701 is a preferential cache entry (e.g., preferential cache line, preferential MMU line). Cache entry 701 includes a tag having one or more bits that indicate that data in cache entry 701 satisfies the cache promotion criteria. In some implementations, data stored in a cache entry satisfies the cache promotion criteria (and thus the cache entry storing the data is a preferential cache entry) when the data includes any of: (i) table walk outputs from a level 2 table (such as a cache entry that stores table descriptor 342 or physical address 390 associated with an output from level 2 table 340 in a one-stage table walk process 300 shown in FIG. 3B), (ii) table walk outputs from a stage 1 level 2 table (such as a cache entry that stores a table descriptor, intermediate physical address, or physical address 490 associated with an output from S1L2 table (e.g., block “15”) in a two-stage table walk process 400 shown in FIG. 4B), and (iii) table walk outputs from any stage 2 table in the fifth row of a two-stage table walk (such as a cache entry that stores a table descriptor, page descriptor, intermediate physical address, or physical address 490 associated with an output from any of S2L0, S2L1, S2L2, S2L3 in the fifth row of a two-stage table walk in a two-stage table walk process 400 shown in FIG. 4B).

Referring to FIG. 7A, in accordance with a determination that the data fetcher (such as data fetcher 208) performs a table walk process to retrieve data in response to a first request (e.g., prefetch request or demand request) for the data, memory controller 110 receives instructions to store the data as a preferential cache entry 701 in cache 392 (e.g., add preferential cache entry 701 to cache 392). In accordance with cache entry 701 being a preferential cache entry, memory controller 110 adds preferential cache entry 701 at a cache line 501 that is at or above the pre-determined cache line 501-x (e.g., a threshold cache line 501-x, a predefined cache line 501-x). For example, if x=3, then memory controller 110 adds preferential cache entry 701 to cache 392 at any cache line that is at LRU+2 cache line 501-3 or higher (e.g., any of LRU+2 cache line 501-3 through MRU cache line 501-P) (e.g., such that preferential cache entry 701 is stored at any cache line between (and including) LRU+2 cache line 501-3 through MRU cache line 501-P of cache 392). In some implementations, memory controller 110 adds preferential cache entry 701 at a cache line 501 that is at or above the pre-determined cache line 501-x (e.g., a threshold cache line 501-x, a predefined cache line 501-x) other than MRU cache line 501-P. For example, if x=3, then memory controller 110 adds preferential cache entry 701 to cache 392 at any cache line that is at LRU+2 cache line 501-3 or higher with the exception of MRU cache line 501-P (e.g., any of LRU+2 cache line 501-3 through MRU-1 cache line 501-(P−1)) (e.g., such that preferential cache entry 701 is stored at any cache line between (and including) LRU+2 cache line 501-3 through MRU-1 cache line 501-(P−1) of cache 392).

In some embodiments, in accordance with a determination that the first request is a demand request, the data is stored in preferential cache entry 701 at MRU cache line 501-P.

In some embodiments, in accordance with a determination that the first request is a prefetch request, the data is stored in preferential cache entry 701 at any cache line 501 that is at or above the pre-determined cache line 501-x (e.g., a threshold cache line 501-x, a predefined cache line 501-x) other than MRU cache line 501-P.

Cache 392 stores preferential cache entry 701 at the selected cache line (in this example, LRU+3 cache line 501-4) until cache entry 701 is evicted from cache 392 (e.g., to make space for a new cache entry), until cache entry 701 is moved (e.g., demoted) to a lower cache line (e.g., LRU+2 cache line 501-3, LRU+1 cache line 501-2, or LRU cache line 501-1) as new cache entries are added to cache 392 over time and cache entry 701 becomes older (e.g., less recently used), or until another request (e.g., prefetch request or demand request) for data stored in preferential cache entry 701 is received by a processor that is in communication with cache 392 (e.g., until any of processors 204-1 through 204-N of processing cluster 202-1 that is in communication with cache 212-1 receives a request for data stored in preferential cache entry 701).

In accordance with a determination that preferential cache entry 701 is selected for replacement before a request for data stored in preferential cache entry 701 is received at a processor that is in communication with cache 392, memory controller 110 demotes preferential cache entry 701 to a lower cache line in cache 392 or evicts preferential cache entry 701 from cache 392 (e.g., cache entry 601 is no longer stored at cache 392) to make space for a new cache entry. In some implementations, the cache replacement policy instructs memory controller 110 to bias away from selecting preferential cache entries that store data that satisfy the cache promotion criteria, such as preferential cache entry 701, for replacement. In such cases, a preferential cache entry (such as preferential cache entry 701) would be not selected for replacement if cache 392 includes at least one non-preferential cache entry (such as non-preferential cache entry 601). Additionally, cache 392 may also store other information in addition to cache entries. For example, cache 392 may store instructions for a processor that is in communication with cache 392 (e.g., instructions for any of processors 204-1 through 204-N that are in communication with cache 212-1). In some implementations, memory controller 110 may select other data (e.g., instructions, data that is not stored in a preferential cache entry) stored in cache 392 for replacement before selecting a preferential cache entry 701 for replacement. For example, the cache replacement policy may instruct memory controller 110 to bias away from selecting cache entries that provide a largest shortcut in a table walk process and thus, bias away from selecting preferential cache entries (e.g., cache entries that store data corresponding to any of: (i) an output from level 2 table 340 (shown in FIG. 3B) in a one-stage table walk process, an output from a stage 1 level 2 table (e.g., S1L2 table in FIG. 4B) in a two-stage table walk process, and (iii) an output from any stage 2 table in the fifth row (e.g., S2L0, S2L1, S2L2, S2L3 in FIG. 4B) of a two-stage table walk) for replacement.

For example, when selecting a victim from cache 392, memory controller 110 considers selecting a cache entry that is stored in LRU cache line 501-1. In accordance that cache line 501-1 stores a preferential cache entry (such as preferential cache entry 701), memory controller 110 selects a non-preferential cache entry (such as non-preferential cache entry 601) for replacement instead of selecting a preferential cache entry. In some implementations, memory controller 110 selects a non-preferential cache entry for replacement instead of selecting a preferential cache entry independently of a cache line at which the non-preferential cache entry is stored at and independently of a cache line at which the preferential cache entry is stored. For example, memory controller 110 may select a non-preferential cache entry for replacement instead of selecting a preferential cache entry even if the non-preferential cache entry is stored at a higher cache line than the preferential cache entry.

FIG. 7B illustrates promotion of preferential cache entry 701 in accordance with a determination that a second request (e.g., subsequent to and distinct from the first request) for data stored in preferential cache entry 701 is received at a processor that is in communication with cache 392 while preferential cache entry 701 is stored in cache 392 (regardless of the cache line 501 at which cache entry 701 is stored). In accordance with a determination that the second request (e.g., prefetch request, demand request) is received at a processor while preferential cache entry 701 is stored in cache 392, the data fetcher passes data stored in preferential cache entry 701 to the processor (e.g., data fetcher 208 passes data stored in preferential cache entry 701 to processor 204-1) and memory controller 110 promotes preferential cache entry 701 to be stored at the highest cache line (e.g., MRU cache line 501-P), thereby increasing (e.g., maximizing) a lifetime of preferential cache entry 701 in cache 392. In some implementations, in response to receiving the second request for data stored in preferential cache entry 701, the tag associated with data stored in preferential cache entry 701 is updated to indicate that cache entry 701 has seen re-use (e.g., cache entry 701 was accessed while stored in cache 392)

In some implementations, in response to subsequent requests (e.g., each subsequent request after the third request) for data stored in cache entry 701, memory controller 110 promotes cache entry 701 to MRU cache line 501-P if cache entry 701 is stored in cache 392 at a cache line that is different from MRU cache line 501-P. In some implementations, in response to each subsequent request, the tag associated with cache entry 701 is updated to indicate the number of times cache entry 701 has been accessed while stored in cache 392.

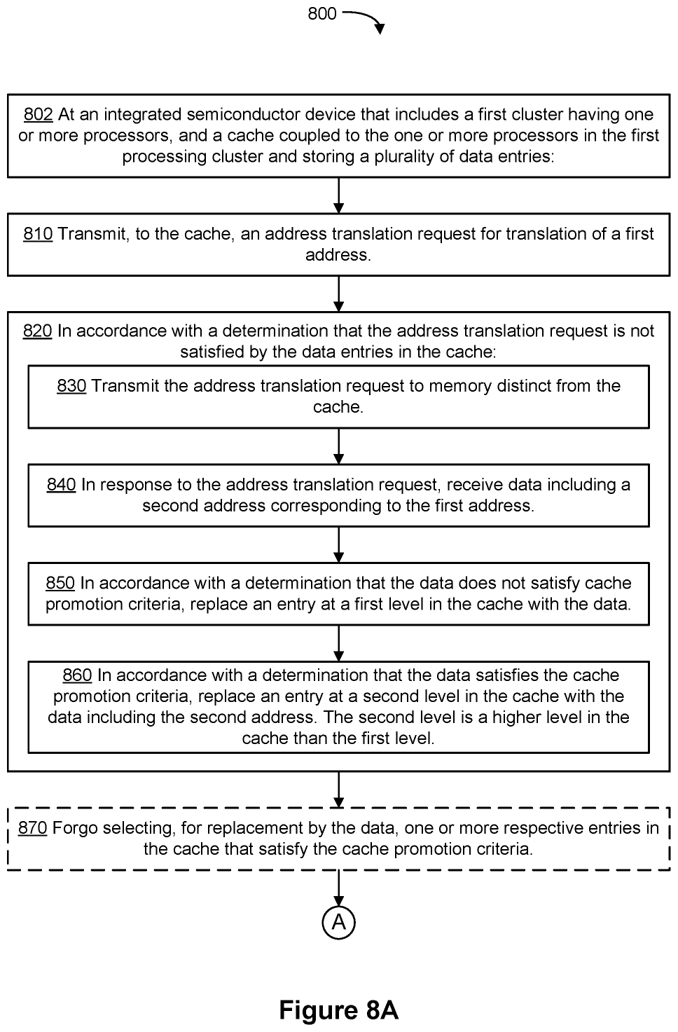

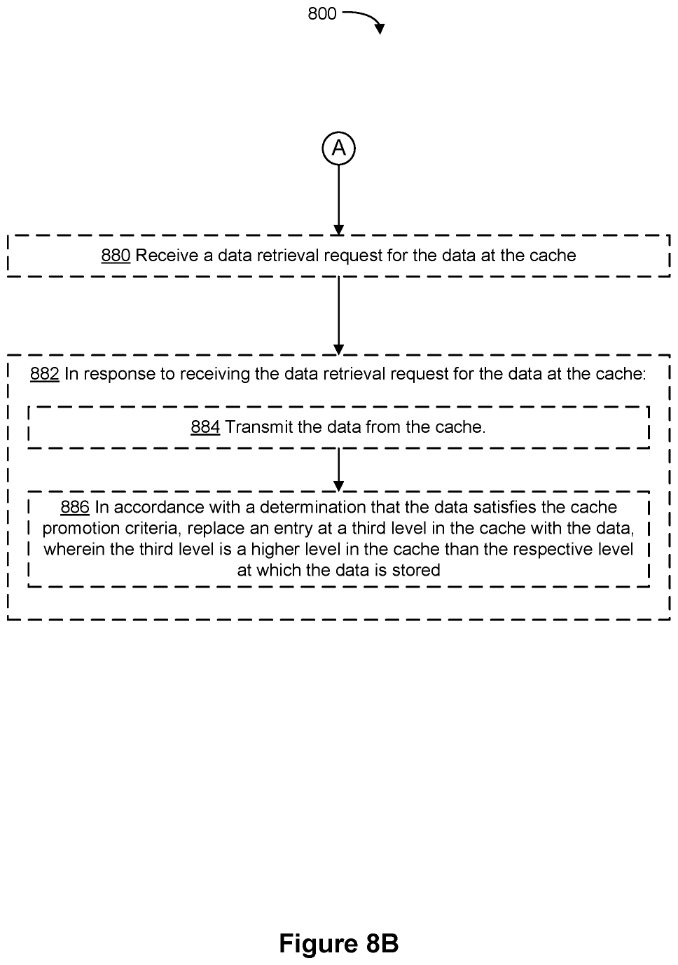

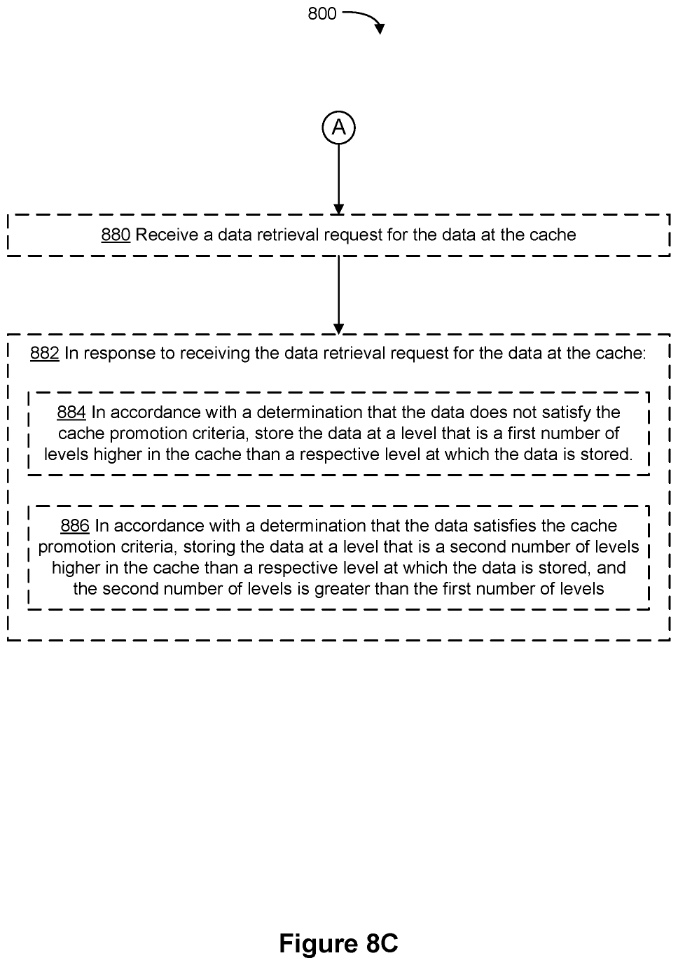

FIGS. 8A-8C illustrate a flow chart of an example method of controlling cache entry (e.g., cache line, memory management unit line) replacement in a cache, in accordance with some implementations. Method 800 is implemented at an electronic device 200 that includes a first processing cluster 202-1 having one or more processors 204, and a cache 212-1 that is coupled to one or more processors 204 in first processing cluster 202-1. Cache 212-1 stores a plurality of data entries. Electronic device 200 transmits (810) an address translation request (e.g., address translation request 310 or 410) for translation of a first address from the first processing cluster 202-1 to cache 212. In accordance with a determination (820) that the address translation request is not satisfied by the data entries in cache 212-2, the electronic device 200 transmits (830) the address translation request to memory (e.g., a lower level cache such as L3 cache 220 or system memory 104, such as DRAM) distinct from cache 212-1. In response to the address translation request (e.g., request 310 or 410), the electronic device 200 receives (840) data including a second address (e.g., the requested address translation, such as physical address 390 or 490) corresponding to the first address (e.g., the received data is requested and retrieved from the lower level cache (such as cache 220) or system memory 104). In accordance with a determination (850) that the data does not satisfy cache promotion criteria (e.g., the data will not be stored as a preferential cache entry), replace an entry (e.g., a cache entry) at a first priority level (e.g., a first cache line) in cache 212-1 with the data (e.g., ceasing to store the replaced entry at the first priority level and storing the received data at the first priority level (in place of the replaced entry), the replaced entry is optionally stored at a level that is lower than the first priority level or evicted from (e.g., no longer stored at) cache 212-1). In accordance with a determination (860) that the data satisfies the cache promotion criteria (e.g., the data will be stored as a preferential cache entry), replace an entry (e.g., cache entry) at a second priority level (e.g., a second cache line) in cache 212-1 with the data including the second address (e.g., ceasing to store the replaced entry at the second priority level and storing the received data at the second priority level (in place of the replaced entry), the replaced entry is optionally stored at a level that is lower than the second priority level or evicted from (e.g., no longer stored at) cache 212-1. The second priority level is a higher priority level in cache 212-1 than the first priority level.

For example, the address translation request includes a request for translation of a virtual address 312 to a physical address (e.g., physical address 390 or 490). In another example, the address translation request includes a request for translation of a virtual address 312 to an intermediate physical address. In yet another example, the address translation request includes a request for translation of an intermediate physical address to another intermediate physical address. In a fourth example, the address translation request includes a request for translation of an intermediate physical address to a physical address.

In some implementations, the address translation request (e.g., request 310 or 410) is a demand request transmitted from the one or more processors (e.g., any of processors 204-1 through 204-N) of the first processing cluster 202-1. In some implementations, the address translation request is transmitted in accordance with the one or more processors 204 executing an instruction requiring translation of the first address (e.g., address 312).

In some implementations, the second priority level indicates a most recently used (MRU) entry in the cache 212-1. In some implementations, in accordance with a determination that the address translation request (e.g., request 310 or 410) is a demand request and the address translation is performed in accordance with a demand request, the retrieved translated address (e.g., physical address 390 or 490) is stored in a cache level (e.g., cache line) that indicates a most recently used entry (e.g., at MRU cache line 501-P) or one of a threshold number of most recently used entries in the cache (e.g., one of two, three, or other number of most recently used entries, such as any cache line that is at or above a threshold cache line 501-x). FIG. 6B illustrates implementation of the cache replacement policy in accordance with a determination that the address translation request is a demand request.

In some embodiments, the address translation request is a prefetch request (e.g., the address translation request is transmitted independently of execution of an instruction requiring translation of the first address). In some implementations, the address translation prefetch request is transmitted in the absence of a specific request (e.g., demand request) from the one or more processors for translation of the first address. In some implementations, the address translation prefetch request is transmitted from prefetching circuitry of the first processing cluster 202-1. In some implementations, where an address translation is performed in response to a prefetch request (e.g., rather than a demand request), the retrieved translated address is stored in a cache level that indicates an entry more recently used than the least recently used entry, but not necessarily the most recently used entry (e.g., the translated address is stored at a lower cache level (e.g., a cache line that is below a threshold cache line 501-x). In some implementations, the translated address is stored at a lower cache line that is below a threshold cache line 501-x but not at the LRU cache line 501-1. In some embodiments, the translated address is stored at the LRU cache line 501-1.

In some implementations, the first priority level indicates a least recently used (LRU) entry in the cache 212-1. An example of storing retrieved data that does not satisfy cache promotion criteria in a cache entry (e.g., non-preferential cache entry, such as cache entry 601) at LRU cache line 501-1 is provided with respect to FIG. 6A.

In some implementations, the received data is stored in a cache level that indicates the least recently used entry in accordance with a determination that the address translation request is a prefetch request. For example, the received data is stored at the LRU cache line 501-1 of cache 392. In some implementations, the data is moved to a cache level that indicates a more recently used entry in response to a subsequent data retrieval request (e.g., a demand request) for the same data (e.g., as described herein with reference to operation 880-886). For example, in response to a subsequent data retrieval request, the cache entry is moved to a higher cache line than a cache line at which the cache entry is currently stored in the cache. An example of storing the retrieved data at a cache entry at LRU cache line 501-1 in response to a first request and promoting the cache entry to a higher cache line (e.g., a higher cache level) in response to a second request is provided above in FIGS. 6A-6C. In some implementations, the first request and the second request are both prefetch requests.

In some implementations, the first priority level (e.g., cache level that is below a threshold cache line 501-x) indicates one of a threshold number of least recently used entries in the cache 212-1 (e.g., of two, three, or other number of least recently used entries). In some implementations, the first priority level indicates the second least recently used entry in the cache 212-1 (e.g., LRU+1 cache line 501-2), the third least recently used entry in the cache (e.g., LRU+2 cache line 501-3), or other less recently used entry in the cache. In some implementations, the received data is stored in a cache level that indicates one of the threshold number of least recently used entries in accordance with a determination that the address translation request is a prefetch request. In some implementations, the data is moved to a cache level that indicates a more recently used entry in response to a subsequent data retrieval request (e.g., a demand request) for the same data (e.g., as described herein with reference to operation 880-886). FIG. 6A illustrates examples of adding data that does not satisfy cache promotion criteria to cache 392 by storing the data in a non-preferential cache entry (such as non-preferential cache entry 601) at a cache line 501 that is below a cache line threshold 501-x (e.g., cache level threshold).

In some implementations, the data satisfies the cache promotion criteria in accordance with a determination that the address translation request for translation of the first address is a request for translation of an intermediate physical address of a respective level to an intermediate physical address of a next level. In an example, the data corresponds to an output from a stage 1 level 2 table (e.g., S1L2 (block “15”) in FIGS. 4A and 4B) in a two-stage table walk process 400. In some implementations, the translation of the intermediate physical address of the respective level to the intermediate physical address of the next level constitutes a last level of translation during a first stage of a two-stage table walk.

In some implementations, the data satisfies the cache promotion criteria in accordance with a determination that the address translation request for translation of the first address is a request for translation of an intermediate physical address to a physical address. For example, the data corresponds to an output from a stage 2 table (e.g., S2L, S2L1, S2L2, and S2L3 tables) in a two-stage table walk process 400. In some implementations, the translation of the intermediate physical address to the physical address constitutes a second stage of translation of a two-stage table walk. In some implementations, the intermediate physical address is obtained from the first stage (e.g., a last level of translation of the first stage, stage 1 level 3 table (S1L3)) of translation of the two-stage table walk.

In some implementations, method 800 further includes forgoing (870) selecting, for replacement by the data, one or more respective entries (e.g., preferential cache entries, such as preferential cache entry 701 storing data that satisfies cache promotion criteria) in the cache that satisfy the cache promotion criteria. In an example, the electronic device 200 avoids selecting any respective entry (e.g., any preferential cache entry that stores data that satisfies cache promotion criteria) that satisfies the cache promotion criteria as a victim for replacement. In some implementations, the replaced entry is selected for replacement in accordance with a determination that the replaced entry fails to satisfy the cache promotion criteria (e.g., a non-preferential cache entry that stores data that does not satisfy cache promotion criteria is selected as a victim for replacement). In some implementations, a cache entry satisfies the cache promotion criteria in accordance with a determination that the entry has satisfied an address translation request to the cache. The cache entry has seen reuse while being stored in the cache. In some implementations, whether a cache entry has satisfied an address translation request is indicated using one or more reuse bits associated with the entry (e.g., a tag stored with the data in the cache entry).

In some implementations, method 800 further includes receiving (880) a data retrieval request (e.g., a second address translation request for translation of the first address, such as a demand request from the first processing cluster 202-1) for data at the cache 212-1, and in response to (882) receiving the data retrieval request for the data at the cache, transmitting (884) the data from the cache 212-1 to the first processing cluster 202-1. In accordance with a determination that the data satisfies the cache promotion criteria, method 800 further includes replacing (886) an entry (e.g., cache entry) at a third level in the cache 212-1 with the data. The third level is a higher priority level in the cache 212-1 than the respective level at which the data is stored. In some implementations, the entry at the third level ceases to be stored at the third level, and is optionally stored at a level lower than the third level. In some implementations, the preferential cache entry (such as preferential cache entry 701) that stores the data is promoted (e.g., moved) to a higher cache line such that the preferential cache entry storing the data is stored at a new cache line that is higher than a cache line at which the preferential cache entry is currently stored. In some implementations, the data is stored at a level indicating a least recently used entry or one of a threshold number of least recently used entries (e.g., at a lower cache line that is below the threshold cache line 501-x) as a result of a prefetch request for the data. In some implementations, over time, the data is moved to progressively lower levels in the cache if data retrieval requests for the data are not received (e.g., the data is demoted or degraded over time with nonuse). In some implementations, a subsequent demand request for the data causes the data to be promoted to a higher priority level in the cache (optionally, a level indicating a most recently used entry (e.g., MRU cache line 501-P), or a level indicating one of a threshold number of most recently used entries (e.g., a higher cache line that is at or above the threshold cache line 501-x)) if the data satisfies the cache promotion criteria.

In some implementations, method 800 further includes receiving (890) a data retrieval request (e.g., a second address translation request for translation of the first address, such as a demand request from the first processing cluster 202-1) for data at the cache 212-1. Method 800 further includes, in response to (892) receiving the data retrieval request for the data at the cache and in accordance with a determination (894) that the data does not satisfy the cache promotion criteria, storing the data at a level that is a first number of levels higher in the cache than a respective level (e.g., the first priority level) at which the data is stored (e.g., storing the data in anon-preferential cache entry at a cache line that is higher than a cache line at which the non-preferential cache entry is stored). In some implementations, the first number is (e.g., an integer) greater than zero, and the data is moved from the respective level (e.g., the first priority level) to a higher priority level, and the entry previously stored at the higher priority level ceases to be stored at the higher priority level, and is optionally stored at a level lower than the higher priority level. In some implementations, the first number of levels is zero, and the data continues to be stored at the respective level. An example is provided with respect to FIG. 6C.

Method 800 further includes, in response to (892) receiving the data retrieval request for the data at the cache and in accordance with a determination (896) that the data satisfies the cache promotion criteria, storing the data at a level that is a second number of levels higher in the cache than a respective level (e.g., the second priority level) at which the data is stored (e.g., storing the data in a preferential cache entry at a cache line that is higher than a cache line at which the preferential cache entry is stored). The second number of levels is greater than the first number of levels. In some implementations, the cache is configured to replace the entry previously stored at the higher priority level in the cache with the data. In some implementations, in response to a subsequent request for data stored in the cache (e.g., a demand request for prefetched data), if the data satisfies the cache promotion criteria, the data is promoted in the cache more than if the data does not satisfy the cache promotion criteria.

Cache translation to physical addresses is implemented such that each physical address can be accessed using a virtual address as an input. When TLBs miss a virtual address, a memory management unit (MMU) performs a table-walk process to access a tree-like translation table stored in memory. The tree-like translation table includes a plurality of page tables. The table-walk process includes a sequence of memory accesses to the page tables stored in the memory. In some embodiments, these memory accesses of the table-walk process are line-size accesses, e.g., to 64B cache lines that are allowed to be cached in a cache hierarchy distinct from a TLB hierarchy. In some situations, these cache lines associated with the line-size accesses are applied in the L2 and/or L3 cache and not in the L1 cache. Specifically, each of the 64B lines applied in the L2 cache holds multiple descriptors, and the table-walk process identifies at least a subset of descriptors. Various implementations of this application can be applied to enable cache replacement in the L2 cache. A set of levels or steps of the table-walk process (e.g., certain memory accesses or replacement to the L2 cache) are associated with a higher priority and given preferential treatment in the L2 cache compared with other L2 cache accesses or replacement.

It should be understood that the particular order in which the operations in FIG. 8 have been described are merely exemplary and are not intended to indicate that the described order is the only order in which the operations could be performed. One of ordinary skill in the art would recognize various ways to reorder the operations described herein. Additionally, it should be noted that details of other processes described herein with respect to method 800 (e.g., FIG. 8) are also applicable in an exchangeable manner. For brevity, these details are not repeated here.

The above description has been provided with reference to specific embodiments. However, the illustrative discussions above are not intended to be exhaustive or to be limiting to the precise forms disclosed. Many modifications and variations are possible in view of the above teachings. The embodiments were chosen and described in order to best explain the principles disclosed and their practical applications, to thereby enable others to best utilize the disclosure and various embodiments with various modifications as are suited to the particular use contemplated.

Implementation examples are described in at least the following numbered clauses:

Clause 1: An electronic device, comprising: a first processing cluster including one or more processors; and a cache coupled to the one or more processors in the first processing cluster and storing a plurality of data entries; wherein the electronic device is configured to: transmit to the cache an address translation request for translation of a first address; in accordance with a determination that the address translation request is not satisfied by the data entries in the cache: transmit the address translation request to memory distinct from the cache; in response to the address translation request, receive data including a second address corresponding to the first address; in accordance with a determination that the data does not satisfy cache promotion criteria, replacing an entry at a first priority level in the cache with the data; and in accordance with a determination that the data satisfies the cache promotion criteria, replacing an entry at a second priority level in the cache with the data including the second address, wherein the second priority level is a higher priority level in the cache than the first priority level.

Clause 2: The electronic device of clause 1, wherein the address translation request is a demand request transmitted from the one or more processors of the first processing cluster.

Clause 3: The electronic device of clause 2, wherein the second priority level indicates a most recently used entry in the cache.

Clause 4: The electronic device of any of the preceding clauses, wherein the address translation request is a prefetch request.

Clause 5: The electronic device of any of the preceding clauses, wherein the first priority level indicates a least recently used entry in the cache.

Clause 6: The electronic device of any of clauses 1-4, wherein the first priority level indicates one of a threshold number of least recently used entries in the cache.

Clause 7: The electronic device of any of the preceding clauses, wherein the data satisfies the cache promotion criteria in accordance with a determination that the address translation request for translation of the first address is a request for translation of an intermediate physical address of a respective level to an intermediate physical address of a next level.

Clause 8: The electronic device of any of clauses 1-6, wherein the data satisfies the cache promotion criteria in accordance with a determination that the address translation request for translation of the first address is a request for translation of an intermediate physical address to a physical address.

Clause 9: The electronic device of any of the preceding clauses, including forgoing selecting, for replacement by the data, one or more respective entries in the cache that satisfy the cache promotion criteria.

Clause 10: The electronic device of any of the preceding clauses, wherein the cache is configured to: receive a data retrieval request for the data; in response to receiving the data retrieval request for the data: transmit the data; and in accordance with a determination that the data satisfies the cache promotion criteria, replace an entry at a third level in the cache with the data, wherein the third level is a higher priority level in the cache than the respective level at which the data is stored.

Clause 11: The electronic device of any of clauses 1-9, wherein the cache is configured to: receive a data retrieval request for the data; in response to receiving the data retrieval request for the data: transmit the data; and in accordance with a determination that the data does not satisfy the cache promotion criteria, storing the data at a level that is a first number of levels higher in the cache than a respective level at which the data is stored; and in accordance with a determination that the data satisfies the cache promotion criteria, storing the data at a level that is a second number of levels higher in the cache than a respective level at which the data is stored, and the second number of levels is greater than the first number of levels.

Clause 12: A method executed at an electronic device that includes a first processing cluster having one or more processors, and a cache coupled to the one or more processors in the first processing cluster and storing a plurality of data entries, the method comprising: transmitting an address translation request for translation of a first address to the cache; in accordance with a determination that the address translation request is not satisfied by the data entries in the cache: transmitting the address translation request to memory distinct from the cache; in response to the address translation request, receiving data including a second address corresponding to the first address; in accordance with a determination that the data does not satisfy cache promotion criteria, replacing an entry at a first priority level in the cache with the data; and in accordance with a determination that the data satisfies the cache promotion criteria, replacing an entry at a second priority level in the cache with the data including the second address, wherein the second priority level is a higher priority level in the cache than the first priority level.

Clause 13: The method of clause 12, wherein the address translation request is a demand request transmitted from the one or more processors of the first processing cluster.

Clause 14: The method of clause 13, wherein the second priority level indicates a most recently used entry in the cache.

Clause 15: The method of any of clauses 12-14, wherein the address translation request is a prefetch request.

Clause 16: The method of any of clauses 12-15, wherein the first priority level indicates a least recently used entry in the cache.

Clause 17: The method of any of clauses 12-15, wherein the first priority level indicates one of a threshold number of least recently used entries in the cache.

Clause 18: The method of any of clauses 12-17, wherein the data satisfies the cache promotion criteria in accordance with a determination that the address translation request for translation of the first address is a request for translation of an intermediate physical address of a respective level to an intermediate physical address of a next level.

Clause 19: The method of any of clauses 12-17, wherein the data satisfies the cache promotion criteria in accordance with a determination that the address translation request for translation of the first address is a request for translation of an intermediate physical address to a physical address.

Clause 20: The method of any of clauses 12-19, further comprising: forgoing selecting, for replacement by the data, one or more respective entries in the cache that satisfy the cache promotion criteria.

Clause 21: The method of any of clauses 12-20, further comprising: receiving a data retrieval request for the data at the cache; in response to receiving the data retrieval request for the data at the cache: transmitting the data from the cache; and in accordance with a determination that the data satisfies the cache promotion criteria, replacing an entry at a third level in the cache with the data, wherein the third level is a higher priority level in the cache than the respective level at which the data is stored.

Clause 22: The method of any of clauses 12-20, further comprising: receiving a data retrieval request for the data at the cache; in response to receiving the data retrieval request for the data at the cache: transmitting the data from the cache; and in accordance with a determination that the data does not satisfy the cache promotion criteria, storing the data at a level that is a first number of levels higher in the cache than a respective level at which the data is stored; and in accordance with a determination that the data satisfies the cache promotion criteria, storing the data at a level that is a second number of levels higher in the cache than a respective level at which the data is stored, and the second number of levels is greater than the first number of levels.

Clause 23: A non-transitory computer readable storage medium storing one or more programs configured for execution by an electronic device that comprises a first processing cluster including one or more processors, and a cache coupled to the one or more processors in the first processing cluster and storing a plurality of data entries, the one or more programs including instructions that, when executed by the electronic device, cause the electronic device to perform a method of any of clauses 12-22.

Clause 24: An electronic device that includes a first processing cluster having one or more processors, and a cache coupled to the one or more processors in the first processing cluster and storing a plurality of data entries, comprising at least one means for performing a method of any of clauses 12-22.

The above description has been provided with reference to specific implementations. However, the illustrative discussions above are not intended to be exhaustive or to be limiting to the precise forms disclosed. Many modifications and variations are possible in view of the above teachings. The implementations were chosen and described in order to best explain the principles disclosed and their practical applications, to thereby enable others to best utilize the disclosure and various implementations with various modifications as are suited to the particular use contemplated.

The terminology used in the description of the various described implementations herein is for the purpose of describing particular implementations only and is not intended to be limiting. As used in the description of the various described implementations and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. Additionally, it will be understood that, although the terms “first,” “second,” etc. may be used herein to describe various elements, these elements should not be limited by these terms. These terms are only used to distinguish one element from another.

As used herein, the term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

Although various drawings illustrate a number of logical stages in a particular order, stages that are not order dependent may be reordered and other stages may be combined or broken out. While some reordering or other groupings are specifically mentioned, others will be obvious to those of ordinary skill in the art, so the ordering and groupings presented herein are not an exhaustive list of alternatives. Moreover, it should be recognized that the stages can be implemented in hardware, firmware, software or any combination thereof

What is claimed is:

1. An electronic device, comprising:
a first processing cluster including one or more processors; and
a cache coupled to the one or more processors in the first processing cluster and storing a plurality of data entries;
wherein the electronic device is configured to:
transmit to the cache an address translation request for translation of a first address;
in accordance with a determination that the address translation request is not satisfied by the data entries in the cache:
transmit the address translation request to memory distinct from the cache;
in response to the address translation request, receive data including a second address corresponding to the first address;
in accordance with a determination that the data does not satisfy cache promotion criteria, replacing an entry at a first priority level in the cache with the data; and
in accordance with a determination that the data satisfies the cache promotion criteria, replacing an entry at a second priority level in the cache with the data including the second address, wherein the second priority level is a higher priority level in the cache than the first priority level.

2. The electronic device of claim 1, wherein the address translation request is a demand request transmitted from the one or more processors of the first processing cluster.

3. The electronic device of claim 2, wherein the second priority level indicates a most recently used entry in the cache.

4. The electronic device of claim 1, wherein the address translation request is a prefetch request.

5. The electronic device of claim 1, wherein the first priority level indicates a least recently used entry in the cache.

6. The electronic device of claim 1, wherein the first priority level indicates one of a threshold number of least recently used entries in the cache.

7. The electronic device of claim 1, wherein the data satisfies the cache promotion criteria in accordance with a determination that the address translation request for translation of the first address is a request for translation of an intermediate physical address of a respective level to an intermediate physical address of a next level.

8. The electronic device of claim 1, wherein the data satisfies the cache promotion criteria in accordance with a determination that the address translation request for translation of the first address is a request for translation of an intermediate physical address to a physical address.

9. The electronic device of claim 1, including forgoing selecting, for replacement by the data, one or more respective entries in the cache that satisfy the cache promotion criteria.

10. The electronic device of claim 1, wherein the cache is configured to:
receive a data retrieval request for the data;
in response to receiving the data retrieval request for the data:
transmit the data; and
in accordance with a determination that the data satisfies the cache promotion criteria, replace an entry at a third level in the cache with the data, wherein the third level is a higher priority level in the cache than the respective level at which the data is stored.

11. The electronic device of claim 1, wherein the cache is configured to:
receive a data retrieval request for the data;
in response to receiving the data retrieval request for the data:
transmit the data; and
in accordance with a determination that the data does not satisfy the cache promotion criteria, storing the data at a level that is a first number of levels higher in the cache than a respective level at which the data is stored; and
in accordance with a determination that the data satisfies the cache promotion criteria, storing the data at a level that is a second number of levels higher in the cache than a respective level at which the data is stored, and the second number of levels is greater than the first number of levels.

12. A method executed at an electronic device that includes a first processing cluster having one or more processors, and a cache coupled to the one or more processors in the first processing cluster and storing a plurality of data entries, the method comprising:
transmitting an address translation request for translation of a first address to the cache;
in accordance with a determination that the address translation request is not satisfied by the data entries in the cache:
transmitting the address translation request to memory distinct from the cache;
in response to the address translation request, receiving data including a second address corresponding to the first address;
in accordance with a determination that the data does not satisfy cache promotion criteria, replacing an entry at a first priority level in the cache with the data; and
in accordance with a determination that the data satisfies the cache promotion criteria, replacing an entry at a second priority level in the cache with the data including the second address, wherein the second priority level is a higher priority level in the cache than the first priority level.

13. The method of claim 12, wherein the address translation request is a demand request transmitted from the one or more processors of the first processing cluster.

14. The method of claim 13, wherein the second priority level indicates a most recently used entry in the cache.

15. The method of claim 12, wherein the address translation request is a prefetch request.

16. The method of claim 12, wherein the first priority level indicates a least recently used entry in the cache.

17. The method of claim 12, wherein the first priority level indicates one of a threshold number of least recently used entries in the cache.

18. The method of claim 12, wherein the data satisfies the cache promotion criteria in accordance with a determination that the address translation request for translation of the first address is a request for translation of an intermediate physical address of a respective level to an intermediate physical address of a next level.

19. The method of claim 12, wherein the data satisfies the cache promotion criteria in accordance with a determination that the address translation request for translation of the first address is a request for translation of an intermediate physical address to a physical address.

20. The method of claim 12, further comprising:
forgoing selecting, for replacement by the data, one or more respective entries in the cache that satisfy the cache promotion criteria.

21. The method of claim 12, further comprising:
receiving a data retrieval request for the data at the cache;
in response to receiving the data retrieval request for the data at the cache:
transmitting the data from the cache; and
in accordance with a determination that the data satisfies the cache promotion criteria, replacing an entry at a third level in the cache with the data, wherein the third level is a higher priority level in the cache than the respective level at which the data is stored.

22. The method of claim 12, further comprising:
receiving a data retrieval request for the data at the cache;
in response to receiving the data retrieval request for the data at the cache:
transmitting the data from the cache; and
in accordance with a determination that the data does not satisfy the cache promotion criteria, storing the data at a level that is a first number of levels higher in the cache than a respective level at which the data is stored; and
in accordance with a determination that the data satisfies the cache promotion criteria, storing the data at a level that is a second number of levels higher in the cache than a respective level at which the data is stored, and the second number of levels is greater than the first number of levels.

23. A non-transitory computer readable storage medium storing one or more programs configured for execution by an electronic device that comprises a first processing cluster including one or more processors, and a cache coupled to the one or more processors in the first processing cluster and storing a plurality of data entries, the one or more programs including instructions that, when executed by the electronic device, cause the electronic device to:
transmit to the cache an address translation request for translation of a first address;
in accordance with a determination that the address translation request is not satisfied by the data entries in the cache:
transmit the address translation request to memory distinct from the cache;
in response to the address translation request, receive data including a second address corresponding to the first address;
in accordance with a determination that the data does not satisfy cache promotion criteria, replacing an entry at a first priority level in the cache with the data; and
in accordance with a determination that the data satisfies the cache promotion criteria, replacing an entry at a second priority level in the cache with the data including the second address, wherein the second priority level is a higher priority level in the cache than the first priority level.

24. The non-transitory computer readable storage medium of claim 23, wherein the address translation request is a demand request transmitted from the one or more processors of the first processing cluster.

25. The non-transitory computer readable storage medium of claim 24 wherein the second priority level indicates a most recently used entry in the cache.

26. The non-transitory computer readable storage medium of claim 23, wherein the address translation request is a prefetch request.

27. The non-transitory computer readable storage medium of claim 23, wherein the first priority level indicates a least recently used entry in the cache.

28. An electronic device that includes a first processing cluster having one or more processors, and a cache coupled to the one or more processors in the first processing cluster and storing a plurality of data entries, comprising:
means for transmitting to the cache an address translation request for translation of a first address;
means for, in accordance with a determination that the address translation request is not satisfied by the data entries in the cache:
transmitting the address translation request to memory distinct from the cache;
in response to the address translation request, receiving data including a second address corresponding to the first address;
in accordance with a determination that the data does not satisfy cache promotion criteria, replacing an entry at a first priority level in the cache with the data; and
in accordance with a determination that the data satisfies the cache promotion criteria, replacing an entry at a second priority level in the cache with the data including the second address, wherein the second priority level is a higher priority level in the cache than the first priority level.

29. The electronic device of claim 28, further comprising:
means for receiving a data retrieval request for the data at the cache;
means for, in response to receiving the data retrieval request for the data at the cache:
transmitting the data from the cache; and
in accordance with a determination that the data satisfies the cache promotion criteria, replacing an entry at a third level in the cache with the data, wherein the third level is a higher priority level in the cache than the respective level at which the data is stored.

30. The electronic device of claim 28. further comprising:
means for receiving a data retrieval request for the data at the cache;
means for, in response to receiving the data retrieval request for the data at the cache:
transmitting the data from the cache; and
in accordance with a determination that the data does not satisfy the cache promotion criteria, storing the data at a level that is a first number of levels higher in the cache than a respective level at which the data is stored; and
in accordance with a determination that the data satisfies the cache promotion criteria, storing the data at a level that is a second number of levels higher in the cache than a respective level at which the data is stored, and the second number of levels is greater than the first number of levels.
